(19) United States
(12) Patent Application Publication
(10) Pub. No.: US 2006/0040195 A1
(43) Pub. Date: Feb. 23, 2006

(54) Non-magnetic monocomponent negatively chargeable spherical toner and full color image forming apparatus using the same

(75) Inventors: Nobuhiro Miyakawa, Nagano (JP); Toshiaki Yamagami, Nagano (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/202,943

(22) Filed: Aug. 12, 2005

(30) Foreign Application Priority Data
Aug. 17, 2004 (JP) P.2004-237236

(51) Int. Cl. G03G 9/08

(52) U.S. Cl. 430/108.7; 430/111.4; 430/110.3; 430/108.3

(57) ABSTRACT

The present invention provides a non-magnetic monocomponent negatively chargeable spherical toner including: a toner mother particle having a binder resin and a colorant; and an external additive including a hydrophobic inorganic fine particle having a number average primary particle size of 7 to 50 nm and a hydrophobic monodisperse spherical silica particle having a number average primary particle size of 70 to 130 nm, wherein the non-magnetic monocomponent negatively chargeable spherical toner has a mechanical strength of from 7 to 19 MPa, provided that the mechanical strength is determined from a 10% displacement load of a compression-displacement curve obtained in a microcompression test, wherein the hydrophobic monodisperse spherical silica particle has a work function (Φ_{S}) smaller than a work function (Φ_{TB}) of the toner mother particle, and a image forming apparatus using the toner.

### FIELD OF THE INVENTION

The present invention relates to a non-magnetic monocomponent negatively chargeable spherical toner used in a full color image forming apparatus in which a latent image carrier is made cleanerless, and further to the full color image forming apparatus.

### BACKGROUND OF THE INVENTION

In electrophotography, an electrostatic latent image formed on a latent image carrier provided with a photoconductive material is developed using toner particles containing a colorant, and then, transferred to an intermediate transfer medium. A toner image is further transferred to a recording material such as paper, and fixed by heat, pressure or the like to form duplicated or printed mater. The toner remaining on the latent image carrier after the transfer process contributes the occurrence of white spots in an electrophotographic process in an after-process or ground fogging on the recording material, so that a cleaning means is provided in order to remove the residual toner on the latent image carrier.

As the cleaning means, there has been widely used a so-called blade cleaning system in which a urethane blade or the like is brought into abutting contact with the latent image carrier after the transfer process to scrape the residual toner. However, the cleaning means using the blade cleaning system has the problem of shortening the life of the latent image carrier because it causes film scraping to take place on the latent image carrier. Further, the film scraping on the latent image carrier fluctuates the electric capacitance of the latent image carrier, so that it raises the problem of bringing about fluctuations in image forming conditions to deteriorate image quality. Furthermore, a space for installing the cleaning means around the latent image carrier is necessary, which causes the problem of failing to cope with miniaturization of the latent image carrier a request for which has recently been increasing.

Accordingly, image forming apparatuses of a cleanerless system based on so-called “development simultaneous cleaning” in which a potential difference is produced at the time of development to recover a transfer residual toner into a developing unit have been developed (References 1 to 4). Although these image forming apparatuses can be miniaturized, the transfer residual toner, foreign matter and paper powder on the latent image carrier are recovered into the developing unit. As a result, the charge characteristics of a developing agent becomes unstable, which poses the problem of insufficient color reproducibility as well as a decrease in transfer efficiency, the occurrence of fogging and color mixture due to the occurrence of a reversely transferred toner.

As a cleanerless system by non-contact development using a spherical toner having a sphericity of 0.96 or more for high transfer efficiency, there is a system in which a residual toner on a latent image carrier is once recovered to a holding roller and then transferred to an intermediate transfer medium, and cleaning is performed on the intermediate transfer medium (reference 5). It is possible to prevent color mixture of the toner by the use of the holding roller, but there is a problem with respect to the viewpoint of miniaturization of the latent image carrier and the periphery thereof.

Furthermore, in references 6 to 9, high image forming properties and toughness are obtained by using a spherical toner having a specified compressive strength and compressive load as a toner used in a non-magnetic monocomponent development system, and that sufficient charge amount can be imparted by thin layer regulation with a toner layer regulating member (see references 6 to 9). In addition, in reference 10, a charge stability is impaired by embedding of external additive particles in toner mother particles, so that in order to further improve the charge stability in continuous printing, external addition treatment is conducted using monodisperse spherical silica particles as a spacer (see reference 10). However, when the toner mother particles are spherical and hard particles having a high compressive strength and compressive load, the large-sized monodisperse spherical silica particles acting as an external additive easily roll, resulting in easy separation from surfaces of the toner mother particles to cause liberation thereof. In particular, when thin layer regulation with the toner layer regulating member is used, embedding of external additive particles such as a fluidizing agent occurs, which brings about the problem of the occurrence of a reversely charged toner in continuous printing to increase the cleaning toner amount. Further, there is the problem that the filming toner amount on a latent image carrier increases to decrease transfer efficiency, thereby being unable to cope with the problem of making the latent image carrier cleanerless.

[Reference 1] JP 5-53482 A

[Reference 2] JP 8-146652 A

[Reference 3] JP 10-240004 A

[Reference 4] JP 2000-75541 A

[Reference 5] JP 11-249452 A

[Reference 6] JP 2004-109601 A

[Reference 7] JP 6-324526 A

[Reference 8] JP 2001-66895 A

[Reference 9] JP 2004-46117 A

[Reference 10] JP 2002-318467 A

An object of the invention is to provide a non-magnetic monocomponent negatively chargeable spherical toner which can prevent embedding or liberation of external additive particles even when the sphericity of toner mother particles is raised, has high transfer efficiency, and can improve durability in continuous printing.

Another object of the invention is to provide a full color image forming apparatus which can decrease the toner filming amount and transfer residual toner amount on a latent image carrier, can make the latent image carrier cleanerless, and can miniaturize the image forming apparatus.

### SUMMARY OF THE INVENTION

The present inventors have made eager investigation to examine the problem. As a result, it has been found that the foregoing objects can be achieved by the following toner and image forming apparatus. With this finding, the present invention is accomplished.

The present invention is mainly directed to the following items:

(1) A non-magnetic monocomponent negatively chargeable spherical toner comprising: a toner mother particle comprising a binder resin and a colorant; and an external additive comprising a hydrophobic inorganic fine particle having a number average primary particle size of 7 to 50 nm and a hydrophobic monodisperse spherical silica particle having a number average primary particle size of 70 to 130 nm, wherein the non-magnetic monocomponent negatively chargeable spherical toner has a mechanical strength of from 7 to 19 MPa, provided that the mechanical strength is determined from a 10% displacement load of a compression-displacement curve obtained in a microcompression test, wherein the hydrophobic monodisperse spherical silica particle has a work function (Φₛ) smaller than a work function (Φ_{TB}) of the toner mother particle.

(2) The non-magnetic monocomponent negatively chargeable spherical toner according to item 1, wherein, in number-based particle size distribution measured with a flow type particle image analyzer, the toner mother particle have: a number average primary particle size of 9 μm or less; a particle size distribution that has an integrated value of particle sizes of 3 μm or less of 1% or less; and an average sphericity of 0.970 to 0.985.

(3) The non-magnetic monocomponent negatively chargeable spherical toner according to item 1, wherein the work function (Φ_{TB}) of the toner mother particle is from 5.25 to 5.8 eV, and the work function (Φ_{S}) of the hydrophobic monodisperse spherical silica particle is from 4.90 to 5.20 eV, and the difference between the work function of the toner mother particle and that of the hydrophobic monodisperse spherical silica particle is at least 0.2 eV.

(4) The non-magnetic monocomponent negatively chargeable spherical toner according to item 3, which further comprises a metal soap particle having: a polarity which is the same as that of the toner mother particle; and a work function of from 5.3 to 5.8 eV, wherein the work function of the metal soap particle is at least 0.2 eV larger than that of the hydrophobic monodisperse spherical silica particle, and an absolute value of the difference between the work function of the metal soap particle and that of the toner mother particle is 0.15 eV or less.

(5) The non-magnetic monocomponent negatively chargeable spherical toner according to item 1, wherein the toner mother particle are obtained by a solution suspension method.

(6) A full color image forming apparatus comprising: non-magnetic monocomponent negatively chargeable spherical toners; a latent image carrier; a plurality of developing units each for developing an electrostatic latent image, without contacting the latent image carrier, by using the non-magnetic monocomponent negatively chargeable spherical toners so as to form toner images sequentially on the latent image carrier; an intermediate transfer medium to which the toner images are transferred sequentially so as to form a full color toner image; a recording material to which the full color toner image is transferred and fixed, wherein each of the non-magnetic monocomponent negatively chargeable spherical toners comprising: a toner mother particle comprising a binder resin and a colorant; and an external additive comprising a hydrophobic inorganic fine particle having a number average primary particle size of 7 to 50 nm and a hydrophobic monodisperse spherical silica particle having a number average primary particle size of 70 to 130 nm, wherein each of the non-magnetic monocomponent negatively chargeable spherical toners has a mechanical strength of from 7 to 19 MPa, provided that the mechanical strength is determined from a 10% displacement load of a compression-displacement curve obtained in a microcompression test, wherein the hydrophobic monodisperse spherical silica particle has a work function (Φ_{S}) smaller than a work function ( _{TB}) of the toner mother particle, and the intermediate transfer medium has a work function (Φ_{TM}) smaller than that of a work function (Φ_{T}) of each of the non-magnetic monocomponent negatively chargeable spherical toners.

(7) The full color image forming apparatus according to item 6, wherein, in number-based particle size distribution measured with a flow type particle image analyzer, the toner mother particle have: a number average primary particle size of 9 μm or less; a particle size distribution that has an integrated value of particle sizes of 3 μm or less of 1% or less; and an average sphericity of 0.970 to 0.985.

(8) The full color image forming apparatus according to item 6, wherein the work function (Φ_{TB}) of the toner mother particle is from 5.25 to 5.8 eV, and the work function (Φ_{S}) of the hydrophobic monodisperse spherical silica particle is from 4.90 to 5.20 eV, and the work function (Φ_{TM}) of the intermediate transfer medium is from 4.9 to 5.5 eV, and the work function (Φ_{T}) of each of the non-magnetic monocomponent negatively chargeable spherical toners is from 5.25 to 5.85 eV, wherein the difference between the work function of the toner mother particle and that of the hydrophobic monodisperse spherical silica particle is at least 0.2 eV, and the difference between the work function of the intermediate transfer medium and that of each of the non-magnetic monocomponent negatively chargeable spherical toners is at least 0.2 eV.

(9) The full color image forming apparatus according to item 6, wherein each of the plurality of developing units has a structure in which a toner storage member to which no toner is replenished is integrated with a developing member, wherein the developing member comprises a developing agent carrier and a toner layer regulating member for regulating a toner layer on the developing agent carrier into approximately one layer.

### BRIEF DESCRIPTION OF THE DRAWINGS

FIG. 1 is a view for illustrating a non-contact developing system in an image forming apparatus of the invention.

FIGS. 2A and 2B are views showing a measuring cell used for measuring the work function of a toner, wherein FIG. 2A is a front view, and FIG. 2B is a side view.

FIGS. 3A and 3B are views for illustrating a method for measuring the work function of a cylindrical member of an image forming apparatus, wherein FIG. 3A is a perspective view showing the shape of a measuring test piece, and FIG. 3B is a view showing a measuring state.

FIG. 4 is a diagram showing an example of a chart obtained by measuring the work function of a toner by using a surface analyzer.

FIGS. 5A and 5B are schematic views showing an apparatus used in a method for producing a toner in the invention, wherein FIG. 5A is an enlarged view of a main part thereof, and FIG. 5B is an enlarged sectional view of part A of FIG. 5A for illustrating a state in which an ultrasonic wave is applied.

FIG. 6 is a view showing an embodiment of a full color printer of a 4-cycle system in an image forming apparatus of the invention and for illustrating the case of a latent image carrier having no cleaning means.

FIG. 7 is a view showing an embodiment of a full color printer of a 4-cycle system and for illustrating the case of a latent image carrier having a cleaning means.

FIG. 8 is a view showing an embodiment of a full color image forming apparatus of a tandem developing system and for illustrating the case of a latent image carrier having no cleaning means.

FIGS. 9A and 9B are views for comparing dot reproducibility (dot diameter: 42 μm) using cyan toner 1 of Example 1 and cyan toner C for comparison.

FIG. 10 is a graph showing a number-based particle size distribution measured with a flow type particle image analyzer (FPIA-2100) for cyan toner mother particles 9 in Example 5.

FIG. 11 is a graph showing a number-based particle size distribution measured with a flow type particle image analyzer (FPIA-2100) for cyan toner mother particles D for comparison in Example 5.

The reference numerals used in the drawings denote the followings, respectively.
1: a latent image carrier
2: a charging member
3: an exposing member
4: a developing member
5: an intermediate transfer medium
7: a backup roller
8: a toner supply roller
9: a toner regulating blade (toner layer thickness regulating member)
10: a developing roller
T: a non-magnetic monocomponent toner
L: a developing gap

### DETAILED DESCRIPTION OF THE INVENTION

In a conventional spherical toner whose surface has no irregularity, when pressed by a toner layer regulating blade or the like, external additive particles have their escape cut off to be liable to be embedded in toner mother particle surfaces. It has therefore been considered that the presence of proper irregularity on the toner mother particle surfaces is advantageous for preventing the external additive particles from being embedded. However, in order to increase transfer efficiency of the toner, it is advantageous to allow the sphericity (sphericity) of the toner to infinitely approximate to 1. However, as described above, there is the problem of deteriorated durability caused by embedding of the external additive particles, and the transfer efficiency has been incompatible with the durability.

The present inventors have discovered that liberation from toner mother particles can be prevented by using hydrophobic monodisperse spherical silica particles having a number average primary particle size of 70 to 130 nm as an external additive functioning as a spacer and adjusting the work function thereof to be smaller than that of the toner mother particles, even when the mechanical strength determined at a 10% displacement load of a compression-displacement curve obtained in a microcompression test is as high as 7 to 19 MPa, and the average sphericity thereof is as high as 0.970 to 0.985, thereby being able to prevent the external additive particles functioning as a fluidity improving agent from being embedded in the toner mother particles to provide a non-magnetic monocomponent negatively chargeable spherical toner excellent in durability in continuous printing.

Further, the present inventors have discovered that the toner filming amount on a latent image carrier can be decreased, together with the above-mentioned advantages, by using particles having a number average primary particle size of 9 μm or less in the number-based particle size distribution measured with a flow type particle image analyzer, a particle size distribution that has an integrated value of particle sizes of 3 μm or less of 1% or less and an average sphericity of 0.970 to 0.985, as the above-mentioned toner mother particles, so that a full color image forming apparatus having no problem in print quality can be provided even when the latent image carrier is made cleanerless.

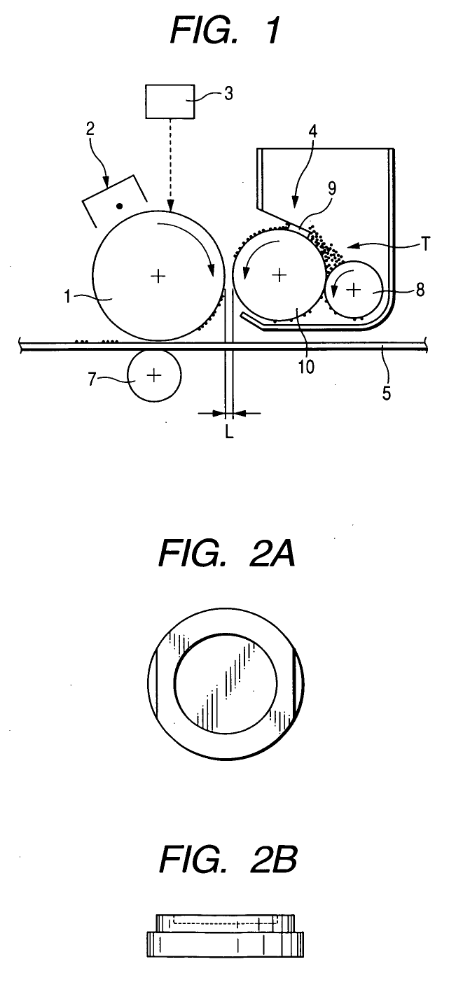

FIG. 1 is a view for illustrating the relationship among a latent image carrier, a developing unit and an intermediate transfer medium in a full color image forming apparatus of the invention. A charging member 2, an exposing member 3, a developing member 4 and an intermediate transfer medium 5 are disposed around the latent image carrier 1. The latent image carrier is brought into contact with only the intermediate transfer medium, and provided with no cleaning blade to make it cleanerless. Referring to FIG. 1, the reference numeral 7 is a backup roller, 8 is a toner supply roller, 9 is a toner regulating blade (toner layer thickness regulating member), 10 is a developing roller, T is a non-magnetic monocomponent negatively chargeable spherical toner, and L is a developing gap.

The latent image carrier 1 is a photoreceptor drum having a diameter of 24 to 86 mm and rotatable at a surface speed of 60 to 300 mm/s, and after a surface thereof has been uniformly negatively charged with a corona charger, exposure 3 corresponding to information to be recorded is performed, thereby forming an electrostatic latent image.

The latent image carrier may be either of an organic monolayer type or of an organic laminate type. The organic laminate type photoreceptor is obtained by laminating a charge generation layer and a charge transport layer, in turn, on a conductive support with the interposition of an undercoat layer.

As the conductive support, a known conductive support can be used. Examples thereof include conductive supports having a volume resistance of 10¹⁰ Ω·cm such as a tubular support having a diameter of 20 to 90 mm obtained by performing processing such as cutting to an aluminum alloy, a support to which conductivity is imparted by vapor deposition of aluminum or application of a conductive coating onto a polyethylene terephthalate film, and a tubular support having a diameter of 20 to 90 mm and a tubular, belt-like, tabular or sheet-like support which are formed of a conductive polyimide resin. As another example, a seamless metal belt made of a nickel electrocast tube or a stainless steal tube is suitably used.

As the undercoat layer provided on the conductive support, a known undercoat layer can be used. For example, the undercoat layer is provided in order to improve adhesiveness, to prevent moire, to improve coating properties of the charge generation layer as an upper layer thereof, and to reduce residual potential at the time of exposure. A resin used as the undercoat layer is desirably a resin high in solvent resistance to a solvent used for a photosensitive layer, because the photosensitive layer is formed thereon. Examples of the available resins include water-soluble resins such as polyvinyl alcohol, casein and sodium polyacrylate, alcohol-soluble resins such as polyvinyl acetate, copolymerized nylon and methoxymethylated nylon, a polyurethane, a melamine resin and an epoxy resin. These may be used either alone or as a combination of two or more thereof. Further, these resins may contain metal oxides such as titanium dioxide and zinc oxide.

As a charge generation pigment used in the charge generation layer, a known material can be used. Examples of the pigments include a phthalocyanine pigment such as metallophthalocyanine or metal-free phthalocyanine, an azulenium salt pigment, a squaric acid methine pigment, an azo pigment having a carbazole skeleton, an azo pigment having a triphenylamine skeleton, an azo pigment having a diphenylamine skeleton, an azo pigment having a dibenzothiophene skeleton, an azo pigment having a fluorene skeleton, an azo pigment having an oxadiazole skeleton, an azo pigment having a bisstilbene skeleton, an azo pigment having a distyryl oxadiazole skeleton, an azo pigment having a distyryl carbazole skeleton, a perylene pigment, an anthraquinone or polycyclic quinone pigment, a quinone imine pigment, a diphenylmethane pigment, a triphenylmethane pigment, a benzoquinone pigment, a naphthoquinone pigment, a cyanine pigment, an azomethine pigment, an indigoid pigment and a bisbenzimidazole pigment. The foregoing charge generation pigments may be used alone or in combination.

Binder resins used in the charge generation layer include a polyvinyl butyral resin, a partially acetalized polyvinyl butyral resin, a polyarylate resin and a vinyl chloride-vinyl acetate copolymer. As for the composition ratio of the charge generation material to the binder resin, the charge generation material is used within the range of 10 to 1000 parts by weight based on 100 parts by weight of the binder resin.

As the charge transport material constituting the charge transport layer, a known material can be used. The charge transport materials include an electron transport material and a hole transport material. The electron transport materials include, for example, electron acceptor materials such as chloranil, tetracyanoethylene, tetracyanoquinodimethane, 2,4,7-trinitro-9-fluorenone, a palladiphenoquinone derivative, a benzoquinone derivative and a naphthoquinone derivative. These electron transport materials may be used either alone or as a combination of two or more thereof.

Examples of the hole transport materials include an oxazole compound, an oxadiazole compounds, an imidazole compound, a triphenylamine compound, a pyrazoline compound, a hydrazone compound, a stilbene compound, a phenazine compound, a benzofuran compound, a butadiene compound, a benzidine compound and derivatives thereof. These electron donor materials may be used either alone or as a combination of two or more thereof. The charge transport layer may contain an antioxidant, an antiaging agent, an ultraviolet absorber or the like for preventing deterioration of these materials.

Binder resins used in the charge transport layer include a polyester, a polycarbonate, a polysulfone, a polyarylate, polyvinyl butyral, polymethyl methacrylate, a polyvinyl chloride resin, a vinyl chloride-vinyl acetate copolymer and a silicone resin. However, a polycarbonate is preferred in terms of compatibility with the charge transport material, film strength, solubility, and stability as a coating material. As for the composition ratio of the charge transport material to the binder resin, the charge transport material is used within the range of 25 to 300 parts by weight based on 100 parts by weight of the binder resin.

In order to form the charge generation layer and the charge transport layer, it is preferred to use a coating solution. Although a solvent used in the coating solution varies depending on the kind of binder resin, examples thereof include, an alcohol such as methanol, ethanol or isopropyl alcohol, a ketone such as acetone, methyl ethyl ketone or cyclohexanone, an amide such as N,N-dimethylformamide or N,N-dimethylacetamide, an ether such as tetrahydrofuran, dioxane or ethylene glycol monomethyl ether, an ester such as methyl acetate or ethyl acetate, an aliphatic halogenated hydrocarbon such as chloroform, methylene chloride, dichloroethylene, carbon tetrachloride, or trichloroethylene, or an aromatic compound such as benzene, toluene, xylene or monochlorobenzene.

For dispersing the charge generation pigment, dispersion and mixing are preferably performed by a mechanical method using a sand mill, a ball mill, an attritor, a planetary mill or the like.

As a coating method for the undercoat layer, the charge generation layer and the charge transport layer, a method such as dip coating, ring coating, spray coating, wire bar coating, spin coating, blade coating, roller coating or air knife coating can be used. Drying after coating is preferably performed by heating at a temperature of 30 to 200° C. for 30 to 120 minutes, after drying at ordinary temperature. The thickness of these layers after drying is preferably within the range of 0.05 to 10 μm, more preferably from 0.1 to 3 μm, for the charge generation layer, and preferably within the range of 5 to 50 μm, more preferably from 10 to 40 μm, for the charge transport layer.

Further, a monolayer organic photoreceptor is prepared by forming a monolayer organic photosensitive layer containing a charge generation agent, a charge transport agent, a sensitizer, a binder, a solvent and the like by coating on a conductive support as described in the above-mentioned organic laminate type photoreceptor, with the interposition of a similar undercoat layer. The negatively chargeable monolayer type organic photoreceptor may be prepared in accordance with a method disclosed, for example, in JP 2000-19746 A.

The charge generation agents used in the monolayer organic photosensitive layer include a phthalocyanine pigment, an azo pigment, a quinone pigment, a perylene pigment, a quinocyatone pigment, an indigo pigment, a bisbenzimidazole pigment and a quinacridone pigment, and preferred are a phthalocyanine pigment and an azo pigment. As the charge transport agents, examples thereof include organic hole transport compounds such as a hydrazone compound, a stilbene compound, a phenylamine compound, an arylamine compound, a diphenylbutadiene compound and an oxazole compound. Further, as the sensitizers, examples thereof include various electron attractive organic compounds such as a palladiphenoquinone derivative, a naphthoquinone derivative and chloranil, which are also known as electron transport materials. As the binders, examples thereof include thermoplastic resins such as a polycarbonate resin, a polyarylate resin and a polyester resin.

The composition ratios of the respective components are preferably from 40 to 75% by weight for the binder, from 0.5 to 20% by weight for the charge generation agent, from 10 to 50% by weight for the charge transport agent, and from 0.5 to 30% by weight for the sensitizer, and preferably from 45 to 65% by weight for the binder, from 1 to 20% by weight for the charge generation agent, from 20 to 40% by weight for the charge transport agent, and from 2 to 25% by weight for the sensitizer. The solvent is preferably a solvent having no solubility to the undercoat layer, and toluene, methyl ethyl ketone and tetrahydrofuran are exemplified.

The respective components are pulverized, dispersed and mixed by using an agitator such as a homo mixer, ball mill, a sand mill, an attritor or a paint conditioner to prepare a coating solution. The coating solution is applied onto the undercoat layer by dip coating, ring coating, spray coating or the like to a thickness after drying of preferably 15 to 40 μm, more preferably 20 to 35 μm, thereby forming the monolayer organic photosensitive layer.

The developing unit reversely develops an electrostatic latent image on the latent image carrier without contact to form a visible image. The developing unit comprises a toner storage member in which the non-magnetic monocomponent toner T is housed and to which no toner is replenished, and the developing unit having the developing roller 10. The toner is supplied to the developing roller 10 by the supply roller 8 which rotates in the counter-clockwise direction as shown in FIG. 1. The developing roller rotates in the counter-clockwise direction as shown in FIG. 1, and transports the toner T supplied by the supply roller 8 to a portion facing to the latent image carrier, with the toner adsorbed by a surface thereof, thereby making the electrostatic latent image on the latent image carrier visible.

As the developing roller, examples thereof include a roller obtained by plating or blasting a surface of a metal pipe having a diameter of 16 to 24 mm, or a roller in which a conductive elastomer layer having a volume resistance value of 10⁴ to 10⁸ Ω·cm and a hardness of 40 to 70° (Asker A hardness), which is composed of NBR, SBR, EPDM, a urethane rubber or a silicone rubber, is formed on a center shaft of the metal pipe. Developing bias voltage is applied to the developing roller through a shaft of the pipe or a center shaft thereof.

As the regulating blade 9, a SUS plate, a phosphor bronze plate, a rubber plate or a thin metal plate to which rubber tips are adhered can be used. The work function at its contact surface with the toner is preferably from 4.8 to 5.4 eV, and preferably smaller than that of the toner. The regulating blade is preferably urged toward the developing roller at a line pressure of 0.08 to 0.6 N/cm by a biasing means such as a spring (not shown) or utilizing its repulsive force as an elastomer, and preferably regulates the transported amount of the toner to 0.3 to 0.6 mg/cm², the layer thickness of the toner on the developing roller to 5 to 20 μm, more preferably to 6 to 10 μm, and the layer form of the toner particles to approximately one layer, thereby being able to provide sufficient frictional charge to the toner particles. In the present invention, the phrase “the regulating blade regulates the layer form of the toner particles to approximately one layer” means that the regulating blade regulates the layer form of the toner particles to have 1 to 1.5 layers. When the layer thickness of the toner on the developing roller is regulated to 2 layers or more (the transported amount of the toner to 0.7 mg/cm²), slipping-through of spherical toner particles occurs to fail to achieve sufficient frictional charge action. Further, small-sized toner particles pass without contacting with the toner layer regulating member to be positively charged, so that they come to be easily mixed in the toner layer after regulation, which contributes to fogging and a decrease in transfer efficiency. Voltage may be applied to the regulating blade 9 to inject charge into the toner in contact with the blade, thereby regulating the charge amount of the toner.

The developing roller 10 faces to the latent image carrier 1 through the developing gap L. The developing gap L is preferably from 100 to 350 μm. Although not shown, the developing bias of direct current (DC) voltage is preferably from −200 to −500 V, and alternating current (AC) voltage superimposed thereon is preferably from 1.5 to 3.5 kHz with a P-P voltage of 1000 to 1800 V. Further, the peripheral speed of the developing roller which rotates in the counter-clockwise direction is preferably set to a peripheral speed ratio of 1.0 to 2.5, more preferably 1.2 to 2.2, based on that of the latent image carrier which rotates in the clockwise direction.

At the portion at which the latent image carrier and the developing roller face to each other, the toner T vibrates between a surface of the developing roller and a surface of the latent image carrier to develop the electrostatic latent image. The toner particles and the latent image carrier come into contact with each other while the toner T vibrates between the surface of the developing roller and the surface of the latent image carrier, so that even when the positively charged toner exists, it can be converted to the negatively charged toner, in terms of the work function described later.

Then, the intermediate transfer medium 5 is sent between the latent image carrier 1 and the backup roller (transfer roller) 7. The transfer roller allows the intermediate transfer medium to be brought into press contact with the latent image carrier, and voltage having reverse polarity to the negatively charged toner is applied thereto as transfer voltage.

As the intermediate transfer medium, Examples thereof include an electron conductive transfer drum or transfer belt. First, the transfer media of the transfer belt system can be divided into two types in which two kinds of substrates are used, one is a belt in which a transfer layer is provided as a surface layer on a film or a seamless belt comprising a resin, and the other is a belt in which a transfer layer is provided as a surface layer on a base layer of an elastic material. Further, the transfer media of the drum system can also be divided into two types in which two kinds of substrates are used. When an organic photosensitive layer is provided on a drum having rigidity, for example, a drum made of aluminum, a transfer layer is provided as an elastic surface layer on a drum substrate having rigidity such as an aluminum substrate to form the transfer medium. Further, when a support of a latent image carrier is in a belt form, or a so-called “elastic photoreceptor” in which a photosensitive layer is provided on an elastic support such as a rubber support, a transfer layer is preferably provided as a surface layer on a drum substrate having rigidity such as an aluminum drum, directly or with the interposition of a conductive intermediate layer.

As the substrate, a known conductive or insulating substrate can be used. In the case of the transfer belt, the volume resistance is preferably from 10⁴ to 10¹² Ω·cm, and more preferably from 10⁶ to 10¹¹ Ω·cm. The transfer belts can be divided into the following two types depending on the substrate used.

As for a material suitable for the film or the seamless belt and a method for preparing the same, a conductive material such as conductive carbon black, conductive titanium oxide, conductive tin oxide or conductive silica is dispersed in an engineering plastic resin such as a modified polyimide, a thermosetting polyimide, a polycarbonate, an ethylene-tetrafluoroethylene copolymer, polyvinylidene fluoride or a nylon alloy, and the resulting resin composition is extruded to form a semiconductive film substrate generally having a thickness of 50 to 500 μm, or to form a seamless substrate. Then, a fluororesin coating having a thickness of 5 to 50 μm is further formed on an outer side thereof as a surface protective layer for reducing surface energy and preventing filming of the toner, thereby obtaining a seamless belt. As a coating method, examples thereof include dip coating, ring coating, spray coating or the like. In order to prevent cracking, elongation and a meandering movement thereof at edges of the transfer belt, tapes such as 80 μm-thick polyethylene terephthalate films or ribs such as urethane rubber ribs are attached on both edges of the transfer belt to use.

When the substrate is prepared from the film sheet, in order to form a belt-like substrate, edges thereof are ultrasonic welded, thereby being able to prepare a belt. Specifically, a conductive layer and a surface layer are provided on the film sheet, and then, ultrasonic welding is conducted, thereby being able to prepare a transfer belt having desired physical properties. More specifically, when a polyethylene terephthalate film having a thickness of 60 to 150 μm is used as an insulating substrate, aluminum is deposited over a surface thereof, and an intermediate layer comprising a resin and a conductive material such as carbon black is further formed thereon by coating as needed, and a semiconductive surface layer comprising a urethane resin, a fluororesin and a conductive material, which has a surface resistance higher than that of the intermediate surface layer, is provided thereon, thereby being able to form the transfer belt. When a resistive layer can be provided which does not require such a large amount of heat in drying after coating, it is also possible to provide the above-mentioned resistive layer after the ultrasonic welding of the aluminum-deposited film, thereby preparing the transfer belt.

As for a material suitable for the elastic substrate such as a rubber and a method for preparing the same, the above-mentioned conductive material is dispersed in a silicone rubber, a urethane rubber, a nitrile rubber (NBR), an ethylene-propylene rubber (EPDM) or the like, and the resulting composition is extruded to prepare a semiconductive rubber belt having a thickness of 0.8 to 2.0 mm. Then, a surface thereof is polished with an abrasive such as sand paper or a polisher to control the surface roughness to a desired value. Although an elastic layer obtained at this time may be used as such, a surface protective layer can be further provided in a similar manner as described above.

In the case of the transfer drum, the volume resistance is preferably within the range of 10⁴ to 10¹² Ω·cm, and more preferably 10⁷ to 10¹¹ Ω·cm. The transfer drum can be prepared by providing a conductive intermediate layer of an elastic material on a cylinder of a metal such as aluminum as needed to form a conductive elastic substrate, and forming thereon, for example, a fluororesin coating having a thickness of 5 to 50 μm as a surface protective layer for reducing surface energy and preventing filming of the toner.

As the conductive elastic substrate, for example, a conductive material such as carbon black, conductive titanium oxide, conductive tin oxide or conductive silica is blended with, kneaded with and dispersed in a rubber material such as a silicone rubber, a urethane rubber, a nitrile rubber (NBR), an ethylene-propylene rubber (EPDM), a butadiene rubber, a styrene-butadiene rubber, an isoprene rubber, a chloroprene rubber, a butyl rubber, an epichlorohydrin rubber or a fluororubber, and the resulting conductive rubber material is molded so as to adhere to an aluminum cylinder preferably having a diameter of 90 to 180 mm, thereby preferably forming a layer having a thickness of 0.8 to 6 mm after polishing and a volume resistance of 10⁴ to 10¹⁰ Ω·cm. Then, a semiconductive surface layer preferably having a thickness of about 15 to 40 μm, which comprises a urethane resin, a fluororesin, a conductive material and fine fluorine-based particles, is provided thereon, thereby being able to form the transfer drum having a desired volume resistance of 10⁷ to 10¹¹ Ω·cm. The surface roughness thereof at this time is preferably 1 μm (Ra) or less. Further, as another example, it is also possible to cover the conductive elastic substrate prepared as described above with a semiconductive tube of a fluororesin or the like and to allow the tube to contract by heating, thereby preparing the transfer drum having the desired surface layer and electric resistance.

A voltage of +250 to +600 V is preferably applied as primary transfer voltage to the conductive layer in the transfer drum or the transfer belt, and in secondary transfer to a transfer material such as paper, a voltage of +400 to +2,800 V is preferably applied as secondary transfer voltage.

The transfer roller 7 preferably has a structure in which an elastic layer, a conductive layer and a resistive surface layer are laminated in this order on a peripheral surface of a metal shaft having a diameter of 10 to 20 mm. As the resistive surface layer, examples thereof include a resistive sheet excellent in flexibility in which fine conductive particles such as conductive carbon are dispersed in a resin such as a fluororesin or polyvinyl butyral or a rubber such as polyurethane. It is preferred that a surface thereof is smooth. The volume resistance value thereof is preferably from 10⁷ to 10¹¹ Ω·cm, and more preferably from 10⁸ to 10¹⁰ Ω·cm, and the film thickness thereof is preferably from 0.02 to 2 mm.

The conductive layer is preferably selected from a conductive resin in which fine conductive particles such as conductive carbon are dispersed in a polyester resin or the like, a metal sheet and a conductive adhesive, and preferably has a volume resistance value of 10⁵ Ω·cm or less. When the transfer roller is used in press contact with the latent image carrier, the elastic layer is required to flexibly deform at the time of pressing, and to quickly return to an original form at the time of release of pressing, and formed by using an elastic body such as a sponge. The foam structure may be either a continuous foam (jointed foam) structure or an independent foam structure. The rubber hardness thereof (Asker C hardness) is preferably from 30 to 80, and the film thickness thereof is preferably from 1 to 5 mm. The latent image carrier can be allowed to contact with the intermediate transfer medium at a wide nip width by elastic deformation of the transfer roller. The pressing load to the latent image carrier by the transfer roller is preferably from 0.245 to 0.588 N/cm, and more preferably from 0.343 to 0.49 N/cm.

In the full color image forming apparatus of the invention, the transfer residual toner on the latent image carrier can be transferred to the intermediate transfer medium, and the amount of the transfer residual toner on the intermediate transfer medium after transfer from the intermediate transfer medium to the recording member such as paper can be decreased, by making the work function of the intermediate transfer medium smaller than that of the toner.

The work function which specifies the full color image forming apparatus of the invention and the non-magnetic monocomponent negatively chargeable spherical toner used therein will be illustrated below.

The work function (Φ) is known as energy necessary for taking electrons out of a material. The smaller the work function is, the more easily the electron is released, and the larger the work function is, the more difficult the electron is to be released. Accordingly, when a material having a smaller work function is brought into contact with a material having a larger work function, the material having a smaller work function is positively charged, and the material having a larger work function is negatively charged. The work function is numerically indicated as energy (eV) for taking electrons out of a material, and can evaluate chargeability by the contact of toners comprising various materials with various members in the image forming apparatus.

The work function (Φ) is measured using a surface analyzer (AC-2, manufactured by Riken Keiki Co., Ltd., a low-energy computing system). In the invention, in this analyzer, a sample is irradiated within the energy scanning range of 3.4 to 6.2 eV for a measuring time of 10 sec/point, using a heavy hydrogen lump, setting the dose of light to 10 nW for a metal-plated developing roller and to 500 nW for measurement of the others, selecting a monochromic light with a spectrograph, and setting the irradiation area to 4 mm square. The work function (Φ) is determined by detecting photoelectrons emitted from a surface of the sample and performing an operation using a work function computing software, and measured with a repetition accuracy (standard deviation) of 0.02 eV. In order to ensure the reproducibility of data, the sample is subjected to measurement after it has been allowed to stand under conditions of a temperature of 25° C. and a humidity of 55% RH for 24 hours.

A measuring cell for toner exclusive use has a shape in which a stainless steel disk having a diameter of 13 mm and a height of 5 mm is provided at the center thereof with a toner receiving concavity having a diameter of 10 mm and a depth of 1 mm, as shown in FIGS. 2A, 2B. A sample toner is placed in the concavity of the cell by using a weighing spoon without compacting, and then leveled with a knife edge. The sample toner is subjected to measurement in that state. The measuring cell filled with the toner is fixed to a specified position on a sample table. Then, the radiation amount is set to 500 nW, the spot size is set to 4 mm square, and measurement is made under conditions of the energy scanning range of 4.2 to 6.2 eV.

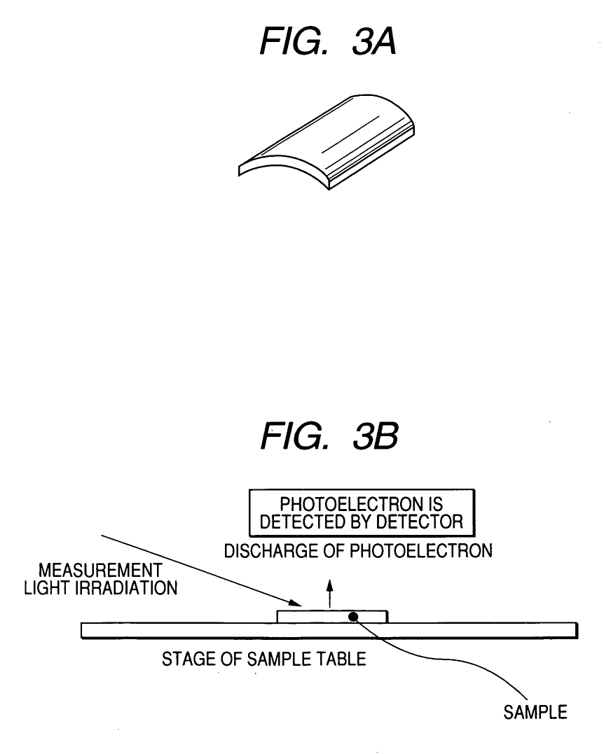

When a cylindrical member of the image forming apparatus such as a photoreceptor or a developing roller is used as the sample, the cylindrical member is cut to a width of 1 to 1.5 cm, and further cut in the lateral direction along ridge lines to obtain a sample piece for measurement of a shape shown in FIG. 3A. Then, the sample piece is fixed to the specified position on the sample table in such a manner that a surface to be irradiated becomes smooth to the direction in which irradiating light is irradiated, as shown in FIG. 3B. Photoelectrons emitted are efficiently detected thereby with a detector (photomultiplier). In the case of an intermediate transfer belt, a regulating blade or a sheet-shaped photoreceptor, it is cut to at least 1 cm square as a sample piece because irradiation is performed to a spot of 4 mm square. The sample piece is fixed to the sample table and measured in the same manner as described with reference to FIG. 3B.

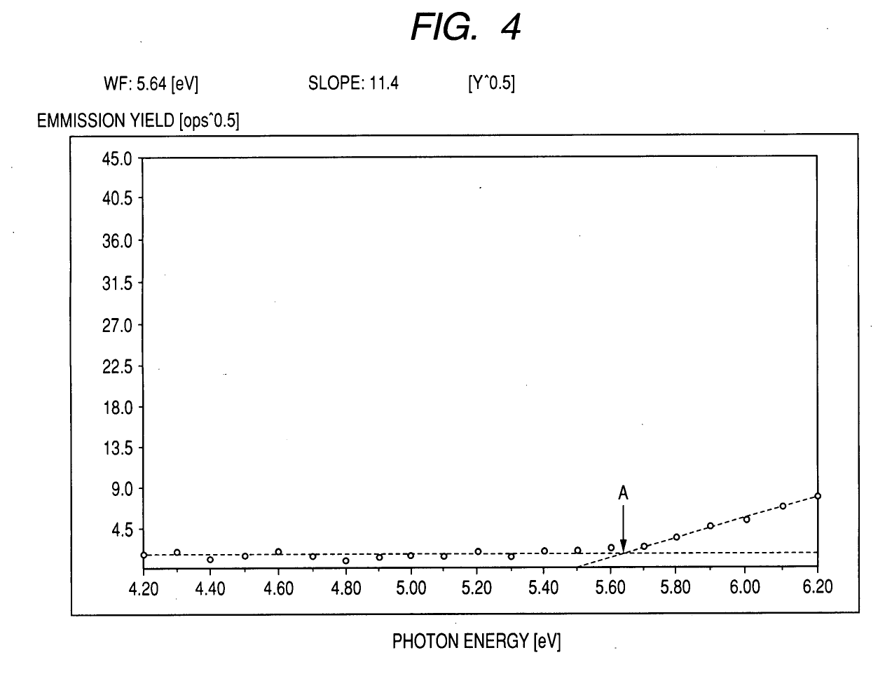

In this surface analysis, photon emission is started at a certain energy value (eV), when excitation energy of monochromatic light is scanned from a lower side to a higher side, and this energy value is called “work function (eV)”. FIG. 4 shows an example of a chart obtained for a toner. In FIG. 4, the excitation energy (eV) is plotted as abscissa and the normalized photon yield (the nth power of the photoelectron yield per unit photon) as ordinate, and a constant slope (Y/eV) is obtained. In the case of FIG. 4, the work function is indicated by an excitation energy value (eV) at a critical point (A).

The work function (Φ_{opc}) of the surface of the latent image carrier (photoreceptor) is preferably from 5.2 to 5.6 eV, and more preferably from 5.25 to 5.5 eV. Less than 5.2 eV causes the problem that it becomes difficult to select the available charge transport agent, whereas exceeding 5.6 eV causes the problem that it becomes difficult to select the available charge generation agent.

The work function (Φ_{TM}) of the surface of the intermediate transfer medium is preferably from 4.9 to 5.5 eV, and more preferably from 4.95 to 5.45 eV. When the work function (Φ_{TM}) of the surface of the intermediate transfer medium is larger than 5.5 eV, material design as the toner unfavorably becomes difficult. On the other hand, when it is smaller than 4.9 eV, the amount of a conductive agent in the intermediate transfer medium becomes too much, which causes the problem of decreased mechanical strength of the intermediate transfer medium.

Further, it is preferred that the work function of the regulating blade is smaller that that of the toner, thereby being able to prevent the occurrence of a reversely charged toner.

The non-magnetic monocomponent negatively chargeable spherical toner of the invention will be described below. In the present invention, the non-magnetic monocomponent negatively chargeable spherical toner comprises a toner mother particle and an external additive.

In the invention, the toner mother particle comprises a binder resin and a colorant. The toner mother particles in the invention are not limited depending on the kind of binder resin in the toner mother particles or the production method thereof such as a solution suspension method or a polymerization method, as long as it has a hardness described later. As the binder resin, examples thereof include a homopolymer or copolymer containing styrene or a styrene substituent which is a styrenic resin such as polystyrene, poly-α-methylstyrene, chloropolystyrene, a styrene-chlorostyrene copolymer, a styrene-propylene copolymer, a styrene-butadiene copolymer, a styrene-vinyl chloride copolymer, a styrene-vinyl acetate copolymer, a styrene-maleic acid copolymer, a styrene-acrylate copolymer, a styrene-methacrylate copolymer, a styrene-acrylate-methacrylate copolymer, a styrene-methyl α-chloroacrylate copolymer, a styrene-acrylonitrile-acrylate copolymer or a styrene-vinyl methyl ether copolymer, a polyester resin, an epoxy resin, a urethane-modified epoxy resin, a silicone-modified epoxy resin, a vinyl chloride resin, a rosin-modified maleic acid resin, a phenyl resin, polyethylene, polypropylene, an ionomer resin, a polyurethane resin, a silicone resin, a ketone resin, an ethylene-ethyl acrylate copolymer, a xylene resin, a polyvinyl butyral resin, a terpene resin, a phenol resin or an aliphatic or alicyclic hydrocarbon resin. These can be used either alone or in combination. As the binder resin, a polyester resin is preferred in terms of sharp melting properties and toughness.

As the polyester resin, examples thereof include a mixture of a polyester resin having a definite acid value and a partially crosslinked product of the polyester resin with a multivalent metal compound. The polyester resin is a polycondensation product of a bifunctional carboxylic acid and a diol. The bifunctional carboxylic acid is, for example, a divalent carboxylic acid, an anhydride of the divalent carboxylic acid or a derivative of an ester thereof, and examples thereof include terephthalic acid, isophthalic acid, phthalic acid, diphenyl-p,p′-dicarboxylic acid, naphthalene-2,7-dicarboxylic acid, naphthalene-2,6-dicarboxylic acid, diphenylmethane-p,p′-dicarboxylic acid, benzophenone-4,4′-dicarboxylic acid, 1,2-diphenoxyethane-p,p′-dicarboxylic acid, maleic acid, fumaric acid, glutaric acid, cyclohexanedicarboxylic acid, succinic acid, malonic acid, adipic acid, an anhydride thereof or an esterified product thereof.

Further, as the diol component, examples thereof include, an alkylene glycol such as ethylene glycol, diethylene glycol, triethylene glycol, 1,2-propylene glycol, 1,3-propylene glycol, 1,4-butanediol, cyclohexanedimethanol, neopentyl glycol or 1,4-butenediol, bisphenol A, hydrogenated bisphenol A, polyoxypropylene(2,0)-2,2-bis(4-hydroxyphenyl)propane, polyoxyethylene(2,0)-2,2-bis(4-hydroxyphenyl)propane, 2,2′-(1,4-phenylenebisoxy)bisethanol, 1,1′-dimethyl-2,2′-(1,4-phenylenebisoxy)bisethanol or 1,1,1′,1′-tetramethyl-2,2′-(1,4-phenylenebisoxy)bisethanol.

The polyester resin having a definite acid value is obtained by heating and stirring the bifunctional carboxylic acid and the diol in the presence of a catalyst such as dibutyltin, and conducting condensation polymerization reaction while removing reaction water.

The partially crosslinked product of the polyester resin with a multivalent metal compound is obtained by putting the multivalent metal compound into a Henschel mixer, a Cyclomix or the like together with the polyester resin, then, putting a specified amount of the resulting mixture into a continuous two-roll kneader, a twin-screw extruder kneader, a planetary mixer, a twin-arm kneader or the like, and kneading the mixture at a maximum temperature of 50° C. for 5 to 15 minutes, thereby conducting reaction.

As the multivalent metal compound, examples thereof include an organic salt or complex containing a divalent or higher valent metal. As the divalent or higher metal, examples thereof include Al, Ba, Ca, Cd, Co, Cr, Cu, Fe, Hg, Mg, Mn, Ni, Pb, Sn, Sr or Zn. Further, the organic metal compounds include a carboxylate, alkoxylate, organic metal complex and chelate compound of the above-mentioned metal. The multivalent metal compound is preferably allowed to react with the polyester resin at a ratio of 1 to 15 parts by weight based on 100 parts by weight of the polyester resin, and the degree of crosslinking of the polyester resin can be adjusted by the reaction amount thereof.

In order to obtain the binder resin, the polyester resin (A) having a definite acid value and the partially crosslinked product (B) of the polyester resin with the multivalent metal compound are preferably blended by adjusting the mixing ratio (weight ratio) thereof so that the hardness as the toner mother particles reaches a value described later, and the resulting mixture is preferably kneaded by a twin-screw extruder kneader at a maximum cylinder temperature of 120° C. for a residence time of 2 to 5 minutes.

A colorant is added to the binder resin, and a release agent, a charge control agent or the like is preferably added thereto. The colorants for full color use include carbon black, lamp black, magnetite, Titan Black, Chrome Yellow, Ultramarine Blue, Aniline Blue, Phthalocyanine Blue, Phthalocyanine Green, Hansa Yellow G, Rhodamine 6G, Calco Oil Blue, Quinacridone, Benzidine Yellow, Rose Bengal, Malachite Green Lake, Quinoline Yellow, C.I. Pigment Red 48:1, C.I. Pigment Red 57:1, C.I. Pigment Red 122, C.I. Pigment Red 184, C.I. Pigment Yellow 12, C.I. Pigment Yellow 17, C.I. Pigment Yellow 97, C.I. Pigment Yellow 180, C.I. Solvent Yellow 162, C.I. Pigment Blue 5:1 and C.I. Pigment Blue 15:3. These dyes and pigments can be used alone or as a mixture thereof.

The release agents include paraffin wax, micro wax, microcrystalline wax, candelilla wax, carnauba wax, rice wax, montan wax, polyethylene wax, polypropylene wax, oxidized polyethylene wax, oxidized polypropylene wax and ester wax. Polyethylene wax, polypropylene wax, carnauba wax and ester wax are preferably used among others.

The charge control agents include oil black, Oil Black BY, Bontron S-22 (manufactured by Orient Chemical Industries, Ltd.), Bontron S-34 (manufactured by Orient Chemical Industries, Ltd.), Salicylic Acid Metal Complex E-81 (manufactured by Orient Chemical Industries, Ltd.), a thioindigo pigment, a sulfonylamine derivative of copper phthalocyanine, Spilon Black TRH (manufactured by Hodogaya Chemical Co., Ltd.), a calixarene-based compound, an organic boron compound, a fluorine-containing quaternary ammonium salt compound, a monoazo metal complex, an aromatic hydroxycarboxylic acid-based metal complex, an aromatic dicarboxylic acid-based metal complex and a polysaccharide. For a color toner, a colorless or white agent is preferred among others.

As for the ratio of components in the toner mother particles, the amount of the colorant is preferably from 0.5 to 15 parts by weight, and more preferably from 1 to 10 parts by weight, the amount of the release agent is preferably from 1 to 10 parts by weight, and more preferably from 2.5 to 8 parts by weight, and the amount of the charge control agent is preferably from 0.1 to 7 parts by weight, and more preferably from 0.5 to 5 parts by weight, based on 100 parts by weight of the binder resin. The hardness of the toner particles is also adjustable by the ratio of the release agent added.

A granulation method of the toner mother particles will be described below. From the spherical shape of the toner mother particles and the sharpness of particle size distribution, granulation is preferably performed by a solution suspension process. The above-mentioned composition is dispersed and dissolved in an organic solvent to form an oily solution, and then, the oily solution is injected into an aqueous solution containing a dispersion stabilizer and an emulsifier through fine pores of a porous glass to form emulsion oil droplets, followed by removal of the organic solvent to obtain the toner mother particles. When the emulsion oil droplets are formed, the emulsion oil droplets formed in the aqueous solution at the injection stage are preferably vibrated to form fine emulsion particles corresponding to the toner particle size.

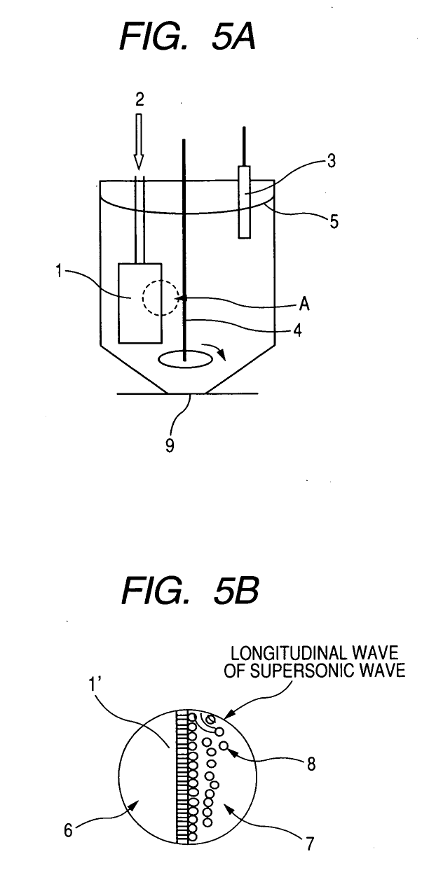

An outline of a production apparatus thereof is shown in FIG. 5A, and an outline of an enlarged cross section of portion A in FIG. 5A is shown in FIG. 5B. Referring to FIGS. 5A and 5B, the reference numeral 1 is a cylindrical unit for injecting an oily solution, on a side face of which a porous glass 1′ is disposed, 2 is a direction in which the oily solution is introduced, 3 is an ultrasonic element, 4 is a stirring blade, 5 is a stirring water level, 6 is the oily solution, 7 is an aqueous solution, 8 is emulsion oil droplets, and 9 is a bottom of a vessel.

As shown in FIGS. 5A and 5B, the porous glass (oily solution injecting-unit) is disposed in the vessel, and the oily solution injected from an upper portion 2 of the oily solution injecting-unit is injected into the aqueous solution through the fine pores 1″ of the porous glass 1′ to form the emulsion oil droplets corresponding to the toner particle size. In the course of forming the emulsion oil droplets in the injection of the oily solution into the aqueous solution, a trailing phenomenon of the oil droplets conceivably occurs at outlets of the fine pores of the porous glass, and tail portions break to generate minute particle-sized oil droplets. The trailing phenomenon can be decreased by vibrating the oil droplets 8 formed at the outlets (jet portions) of the fine pores of the porous glass, preferably by vibrating the oil droplets vertically to a direction in which the oily solution is injected into the aqueous solution, thereby being able to prepare the toner mother particles decreased in fine particle components and having a sharp particle size distribution.

In order to vibrate the emulsion oil droplets at the outlets of the fine pores of the porous glass, it is preferred to dispose the ultrasonic element 3 above the porous glass in the aqueous solution, and to use an ultrasonic wave having vertical amplitude, thereby giving vibration to the oil droplets at the outlets of the fine pores in the vertical direction to the vessel.

As the ultrasonic element 3, examples thereof include an ultrasonic homogenizer (Model US-300T, manufactured by Nippon Seiki Seisakusho K.K., output: 300 W, vibrator diameter: 26 mm), which generates vertical amplitude vibrating vertically to the aqueous solution and is controlled by the number of vibration (frequency) and voltage. For example, when the number of vibration is adjusted to 20 kHz and the current value to 400 μA by controlling voltage, vibration having a vertical amplitude of 30 μm can be generated. Further, when the current value is adjusted to 100 μA, vibration having a vertical amplitude of 10 μm can be generated.

The number of vibration of the ultrasonic element is from 1 kHz to 1 MHz, and preferably from 3 kHz to 800 kHz. When it exceeds 1 MHz, the oil droplets become fine particles, unfavorably resulting in a reduction in particle size. On the other hand, when it is less than 1 kHz, the generation of fine particles can not be prevented in the formation of the oil droplets at the outlets of the fine pores, and the particle size tends to become irregular. Further, the vertical amplitude in the ultrasonic element is from 5 to 100 μm, and preferably from 8 to 60 μm, thereby being able to obtain a desired toner particle size. When the vertical amplitude exceeds 100 μm, the oil droplets become too small. On the other hand, when it is less than 5 μm, the oil droplets, conversely, tend to become too large.

As for a disposing position of the ultrasonic element 3, there is no particular limitation on the distance from the porous glass, as long as it is a position at which the vertical vibration of the ultrasonic wave can be imparted vertically to the injecting direction from the porous glass. However, when the porous glass is arranged vertically in the aqueous solution, the ultrasonic element is preferably arranged at a distance about 10 cm above a surface of the porous glass. Further, it may be arranged diagonally above the porous glass, not directly above the porous glass.

Further, in order to vibrate the emulsion oil droplets at the outlets of the fine pores of the porous glass, the porous glass 1′ itself may be directly vibrated by ultrasonic vibration, as well as the above-mentioned method of disposing the ultrasonic element in the aqueous solution. In this case, it is necessary to hold the number of vibration low.

The porous glasses 1′ include, for example, a Shirasu porous glass (manufactured by SPG Technology Co., Ltd.) and an etched film, and the cross section thereof is schematically shown in FIG. 5B. The fine pore size distribution thereof is controllable within a narrow range. The porous glass can have various fine pore sizes ranging from 2 m to 20 μm. However, the fine pore size may be appropriately selected in consideration of the viscosity of the oily solution, injecting conditions, the desired toner particle size, the composition of the aqueous solution and the like. It is desirable that the size of dispersed particles such as the pigment in the oily solution is smaller than the fine pore size. The thickness of the porous glass is from 0.2 to 5 mm from the viewpoint of its mechanical strength at the time of injection of the oily solution. Further, as for surface characteristics, the affinity thereof for the aqueous solution (wetting characteristic) is higher than that for the oily solution.

The viscosity of the oily solution is preferably from 20 to 500 mP·s (cps), and more preferably from 30 to 300 mP·s (cps), at 25° C., when measured using a rotational viscometer. When the viscosity is too high, the critical pressure for allowing the oily solution to pass through the porous glass becomes too high, and clogging becomes liable to occur. On the other hand, when it is too low, the solvent amount increases. Both cases result in inferior productivity.

The oily solution is injected into the oily solution injecting-unit having the porous glass on the side face thereof as shown in FIG. 5A, from the above as indicated by the arrow at a constant pressure. The pressure applied to the oily solution is from 1×10³ to 5×10⁵ Pa, and preferably from 5×10³ to 3×10⁵ Pa, and may be appropriately selected, taking into account the viscosity of the oily solution, the size of the fine pores, the concentration of the aqueous solution and the desired toner particle size. When the fine pore size too small, injection at high pressure is required. When the pressure is too high, the problem arises that the size of the resulting toner particles varies, although the productivity is improved. On the other hand, when it is too low, the problem occurs that the oily solution is can not be injected.

Further, the stirring blade 4 aims at stirring the aqueous solution so that the oil droplets formed are not united, and may be any, as long as it mildly stirs the aqueous solution. Vigorous stirring is unfavorable, because it influences the formation of the oil droplets.

The formation of the fine emulsion particles is schematically shown in FIG. 5B. The oil droplets formed at the outlets of the fine pores of the porous glass receive vibration vertically, that is to say, vertically to a direction in which the oily solution is injected into the aqueous solution, and depart from the surface of the porous glass without the occurrence of trailing. Then, it is conceivable that the dispersing agent and the emulsifier in an aqueous phase are immediately entrapped on surfaces of the oil droplets to form the stable fine emulsion particles having the dispersion or emulsifier on the surfaces of the oil droplets.

The oily solution is a solution in which components constituting the toner mother particles are dispersed and dissolved. In order to prepare the oily solution, the constituent materials of the toner mother particles may be homogeneously kneaded by using a kneader, a loader mill or a twin-screw extruder, and then, coarsely pulverized, followed by dissolving and dispersing the coarsely pulverized product in an organic solvent to obtain the homogeneously dispersed oily solution. Alternatively, after a master batch has been prepared by using the above-mentioned kneader, a necessary binder resin is added thereto, followed by homogeneous kneading. Then, the resulting kneaded product may be coarsely pulverized and then, the coarsely pulverized product may be dissolved and dispersed in a polar organic solvent. Further, omitting the homogeneous kneading process, the above-mentioned constituent materials of the toner mother particles may be mixed in the organic solvent, and then, dissolved and dispersed in a fine particle form with a high-speed stirrer. Furthermore, the constituent materials of the toner mother particles may also be finely dispersed by using a ball mill.

The organic solvents include hydrocarbons such as toluene, xylene and hexane, halogenated hydrocarbons such as methylene chloride, chloroform, dichloroethane, trichloroethane and carbon tetrachloride, alcohols such as ethanol, butanol and isopropyl alcohol, ketones such as acetone, methyl ethyl ketone and methyl isobutyl ketone, ethers such as benzyl alcohol ethyl ether, benzyl alcohol isopropyl ether and tetrahydrofuran and esters such as methyl acetate, ethyl acetate and butyl acetate. These can be used either alone or as a mixture of two or more thereof. The above-mentioned toner constituent materials are dissolved and dispersed in the organic solvent, and the viscosity of the oily solution is adjusted to the above-mentioned viscosity range.

As the aqueous solution into which the oily solution is injected, the aqueous solution in which the dispersing agent and the emulsifier is dissolved and dispersed in waster can be used. The dispersing agents include polyvinyl alcohol, polyvinyl pyrrolidone, hydroxyethyl cellulose, carboxymethyl cellulose, sodium polyacrylate, tricalcium phosphate, hydroxyapatite, calcium carbonate and various metal oxide compounds such as silica.

Further, as the emulsifier used in combination with the dispersion stabilizer, examples thereof include sodium oleate, a sodium alkylbenzenesulfonate such as sodium dodecylbenzenesulfonate, a sodium α-olefinsulfonate, a sodium alkylsulfonate or a sodium alkyldiphenyletherdisulfonate.

The amount of the dispersion stabilizer and emulsifier added is preferably from 0.01 to 10% by weight, and more preferably from 0.1 to 5% by weight, based on the amount of the oil droplets injected.

The oily solution obtained by dissolving and dispersing the toner constituent materials in the organic solvent is injected into the aqueous solution, and the fine emulsion particles corresponding to the toner particle size are granulated. Then, the resulting emulsion solution is heated at a temperature equal to or higher than the boiling point of the organic solvent, or sprayed with a spray dryer in an atmosphere having a temperature equal to or higher than the boiling point of the organic solvent, thereby removing the organic solvent to prepare the toner mother particles. Heating is performed at a temperature equal to or lower than the glass transition temperature of the binder resin, thereby being able to prevent coagulation of the toner mother particles.

In the number-based particle size distribution measured with a flow type particle image analyzer (FPIA-2100, manufactured by Sysmex Corporation), the toner mother particles thus obtained have a number average primary particle size of 9 μm or less, a particle size distribution that has an integrated value of particle sizes of 3 μm or less of 1% or less, and an average sphericity of 0.970 to 0.985.

The number average primary particle size of the toner mother particles is preferably 9 μm or less, and more preferably from 4.5 to 8 μm. Even when a latent image is formed at a high resolution of 1,200 dpi or more, the toner particles having a number average primary particle size larger than 9 μm are deteriorated in reproducibility of the resolution thereof, compared to the toner particles having a smaller particle size. On the other hand, when the particle size is smaller than 4.5 μm, opacifying properties by the toner are lowered, and fluidity is enhanced, so that the amount of an external additive added increases, which unfavorably tends to deteriorate fixing performance.

Further, in the number-based particle size distribution of the toner mother particles, an integrated value of particle sizes of 3 μm or less is preferably 1% or less, more preferably 0.8% or less. When the integrated value of particle sizes of 3 μm or less exceeds 1%, the charge is insufficiently imparted with the toner layer regulating member to generate a reversely charged toner and to increase toner filming on the latent image carrier, resulting in difficulty to make it cleanerless.

Furthermore, as for the shape of the toner mother particles, the toner particles having a shape approximate to a perfect sphere is preferred. Specifically, the average sphericity R represented by the following equation (1) in the toner mother particles is preferably from 0.970 to 0.985, and more preferably from 0.972 to 0.983.
R=L₀/L₁ (1)
wherein L₁ (μm) represents a peripheral length of a projected image of a toner particle to be measured, and L₀ (μm) represents a peripheral length of a perfect circle (perfect geometrical circle) having the same area as that of a projected image of the toner particle to be measured. This make it possible to provide the toner high in transfer efficiency, small in fluctuation of transfer efficiency even when continuously printed and stable in charge amount.

In the present invention, the toner mother particle preferably has a work function (Φ_{TB}) of 5.25 to 5.8 eV.

External addition treatment will be described below. At least hydrophobic inorganic fine particles having a number average primary particle size of 7 to 50 nm and hydrophobic monodisperse spherical silica particles having a number average primary particle size of 70 to 130 nm are externally added to the toner mother particles, and preferably, metal soap particles are further externally added thereto. In the present invention, the hydrophobic monodisperse spherical silica particle has a work function (Φ_{S}) smaller than a work function ( _{TB}) of the toner mother particle. Furthermore, the difference between the work function of the toner mother particle and that of the hydrophobic monodisperse spherical silica particle is preferably at least 0.2 eV. The particle size of the external additive used in the invention is measured by observation under an electron microscope, and indicated as the number average primary particle size.

As the hydrophobic inorganic fine particles having a number average primary particle size of 7 to 50 nm, examples thereof include hydrophobic silica particles. The hydrophobic silica particles having a number average primary particle size of 7 to 50 nm (a BET specific surface area of 30 to 350 m²/g) is added in order to impart negative chargeability and fluidity, and both particles prepared from a halide of silicon by a dry process and particles deposited from a solution of a silicon compound by a wet process can be used. The number average primary particle size of the silica particles is preferably from 7 to 50 nm, and more preferably from 10 to 40 nm. When the number average primary particle size of primary particles of the silica particles is less than 7 nm, the silica particles become easily buried in the toner mother particles and easily negatively chargeable.

The hydrophobic silica particles having a number average primary particle size of 7 to 50 nm are added in an amount of 0.5 to 3 parts by weight based on 100 parts by weight of the toner mother particles. Less than 0.5 part by weight unfavorably results in no effect on imparting fluidity, whereas exceeding 3 parts by weight unfavorably results in deterioration of fixing properties.

The work function of the hydrophobic silica particles is preferably within the range of 5.0 to 5.3 eV, and preferably at least 0.05 eV smaller than that of the toner mother particles. This makes it possible to fixedly adhere the hydrophobic silica particles to the toner mother particles by charge transfer due to the difference in work function.

Further, for high fluidity and charge stability, hydrophobic titanium oxide particles having a number average primary particle size of 10 to 50 nm may be added. The crystal form of the hydrophobic titanium oxide particles may be any of a rutile type, an anatase type and a rutile/anatase mixed crystal type.

The amount of the hydrophobic titanium oxide particles added is preferably from 0.05 to 2 parts by weight, and more preferably from 0.1 to 1.5 parts by weight, based on 100 parts by weight of the toner mother particles. Less than 0.05 part by weight unfavorably results in no effect on imparting fluidity, whereas exceeding 2 parts by weight unfavorably results in an excessively small negative charge amount of the toner. Further, the amount of the hydrophobic titanium oxide particles added is preferably from 10 to 150 pats by weight based on 100 parts by weight of the hydrophobic silica particles having a number average primary particle size of 7 to 50 nm. Less than 10 parts by weight unfavorably results in no effect on prevention of excessive charge, whereas exceeding 150 parts by weight unfavorably results in an excessively small negative charge amount of the toner.

The work function of the hydrophobic titanium oxide particles is within the range of 5.5 to 5.7 eV, and the hydrophobic titanium oxide particles may be externally added to the toner mother particles, together with the small-sized hydrophobic silica particles. However, when the work function of the toner mother particles and that of the titanium oxide particles are approximately equivalent (i.e., the difference between absolute values is within 0.15 eV, preferably within 0.1 eV) to each other, it is preferred that the hydrophobic silica particles are first externally added to the toner mother particles, followed by external addition of the titanium oxide particles together with the metal soap particles described later.

When the work function of the titanium oxide particles is approximately equivalent to that of the toner mother particles, the titanium oxide particles become difficult to be directly adhered to the toner mother particles. On the other hand, the titanium oxide particles can be adhered to the toner mother particles through surfaces of the hydrophobic silica particles with small function work by the contact potential difference, so that charge transfer from the excessively charged hydrophobic silica particles can be made easy to more effectively prevent excessive chargeability of the hydrophobic silica particles.

In addition, various other inorganic and organic external additives for toners, which have a number average primary particle size of 7 to 50 nm, can be used in combination with the above-mentioned external additives. Examples thereof include an external additive containing surface-modified silica particles whose surfaces are modified with an oxide or hydroxide of at least one metal selected from titanium, tin, zirconium and aluminum, at a ratio of 1.5 or less to the silica particles, positively chargeable silica, alumina, zinc oxide, magnesium fluoride, silicon carbide, boron carbide, titanium carbide, zirconium carbide, boron nitride, titanium nitride, zirconium nitride, zirconium oxide, calcium carbonate, magnetite, molybdenum disulfide, a metal titanate such as strontium titanate, a silicon metal salt and fine particles of a resin such as an acrylic resin, a styrene resin or a fluororesin. It is preferred that these external additives have an appropriate work function, in consideration of adhesion properties to the toner mother particles together with the purpose of adding them.

The external additive particles are preferably hydrophobilized with a silane coupling agent, a titanium coupling agent, a higher fatty acid, silicone oil or the like to use. The hydrophobilization rate is 40% or more, and preferably 50% or more. As the silane coupling agent, examples thereof include dimethyldichlorosilane, octyltrimethoxysilane, hexamethyldisilazane, silicone oil, octyltrichlorosilane, decyltrichlorosilane, nonyltrichlorosilane, (4-iso-propylphenyl)trichlorosilane, (4-t-butylphenyl)trichlorosilane, dipentyldichlorosilane, dihexyldichlorosilane, dioctyldichlorosilane, dinonyldichlorosilane, didecyldichlorosilane, didodecyldichlorosilane, (4-t-butylphenyl)octyldichlorosilane, didecenyldichlorosilane, dinonenyldichlorosilane, di-2-ethylhexyldichlorosilane, di-3,3-dimethylpentyldichlorosilane, trihexylchlorosilane, trioctylchlorosilane, tridecylchlorosilane, dioctylmethylchlorosilane, octyldimethylchlorosilane and (4-iso-propylphenyl)diethylchlorosilane.

The total amount of the hydrophobic inorganic fine particle having a number average primary particle size of 7 to 50 nm is preferably from 0.1 to 5 parts by weight, and more preferably from 0.5 to 4.0 parts by weight, based on 100 parts by weight of the toner mother particles. Less than 0.1 part by weight results in insufficiently imparting fluidity or insufficient charge control, whereas exceeding 5 parts by weight results in not only deterioration of fixing properties, but also off-balanced charge.

The hydrophobic monodisperse spherical silica particles having a number average primary particle size of 70 to 130 nm (a BET specific surface area of 5 to 30 m²/g) will be described below. The hydrophobic monodisperse spherical silica particles are externally added, in order to allow them to function as a spacer which prevents the external additive from being embedded in the toner mother particles. The number average primary particle size and the standard deviation value are determined by actual measurement of the size of any 300 particles for images taken under an electron microscope of 100,000 magnifications, and the term “monodisperse” means that the standard deviation value of the number average primary particle size is from 1 to 1.3. Further, as for the shape thereof, the average sphericity R represented by the above-mentioned equation (1) is preferably 0.6 or more, and more preferably 0.8 or more, similarly to the toner shape. The silica particles have a refractive index of about 1.5, and even when the particle size of the hydrophobic monodisperse spherical silica particles is large, the silica particles are excellent in transparency and suitable as an external additive for a color toner.

Ordinary spherical silica particles obtained by a vapor phase method have a particle size of 50 nm at the maximum. the monodisperse spherical silica particles having a particle size of 70 to 130 nm can be obtained by a sol-gel method which is a wet method described in JP 7-91400 B. Further, the particle size, shape and physical properties such as monodisperse properties of the spherical silica particles can be easily controlled by adjusting hydrolysis in the sol-gel method and reaction conditions such as raw material ratio, reaction temperature, stirring speed and feed rate in the polycondensation process. When the number average primary particle size is less than 70 nm, the silica particles do not function as a spacer. On the other hand, when it exceeds 130 nm, the silica particles come to be easily liberated from the toner mother particles even when the work function of the silica particles is made smaller than that of the toner mother particles, which causes a reduction in negative chargeability to raise the problem of an increase in the reversely charged toner.

The work function of the monodisperse spherical silica particles is about 5.07 eV even at the stage at which they are not hydrophobilized, as described later, and lower than the work function of the toner mother particles. However, the monodisperse spherical silica particles are preferably hydrophobilized in respect to environment resistance. It is therefore preferred to select a hydrophobilizing agent so that the work function (Φ_{S}) of the hydrophobic monodisperse spherical silica particles becomes at least 0.2 eV smaller than the work function (Φ_{TB}) of the toner mother particles. The work function (Φ_{S}) of the hydrophobic monodisperse spherical silica particles is preferably 4.90 to 5.20 eV. Such hydrophobilizing agents include dimethyl silicone oil, methyl phenyl silicone oil and methyl hydrogen silicone oil. When hydrophobilized by using amino-modified silicone oil as modified silicone oil, the monodisperse spherical silica particles show a work function larger than the toner mother particles, which unfavorably causes the problem of deteriorated negative chargeability and increased reversely charged toner.

The amount of the silicone oil for treating the monodisperse spherical silica particles is preferably from 0.1 to 10% by weight, and more preferably from 1 to 8% by weight, by weight ratio based on the monodisperse spherical silica particles. In the invention, a silicon oil treatment amount of the alumina fine particles is defined as a weight percent (wt %) of a weight of a silicon oil with respect to a weight of alumina fine particles. When the treating amount is small, the degree of hydrophobilization decreases. On the other hand, when it is large, the treated silica particles become liable to coagulate to unfavorably influence on the function. The degree of hydrophobilization is preferably from 40 to 80%, and more preferably from 50 to 70%.

The amount of the hydrophobic monodisperse spherical silica particles added to the toner mother particles is preferably from 0.05 to 2 parts by weight, and more preferably from 0.1 to 1.5 parts by weight, based on 100 parts by weight of the toner mother particles. When the amount added is small, the hydrophobic monodisperse spherical silica particles can not function as a spacer. On the other hand, when it is large, the problem arises that the toner scatters from the developing roller after thin layer regulation. As for the addition time, it is preferred that the hydrophobic monodisperse spherical silica particles are externally added to the toner mother particles, concurrently with the small-sized hydrophobic silica particles.

In addition to the above-mentioned external additive particles, the metal soap particles are preferably externally added to the toner mother particles of the invention, thereby being able to decrease the number liberation rate of the external additive particles and to prevent the occurrence of fogging.

Example of the metal soap particles include a higher fatty acid salt of a metal selected from zinc, magnesium, calcium and aluminum, and examples thereof include magnesium stearate, calcium stearate, zinc stearate, monoaluminum stearate and trialuminum stearate. The number average primary particle size of the metal soap particles is preferably from 0.5 to 20 μm, and more preferably from 0.8 to 10 μm.

The amount of the metal soap particles added is preferably 0.05 to 0.5 part by weight, and more preferably from 0.1 to 0.3 part by weight, based on 100 parts by weight of the toner mother particles. Less than 0.05 part by weight results in insufficient functions as a lubricant and a binder, whereas exceeding 0.5 part by weight results in the tendency of fogging to conversely increase. It is preferred that the metal soap particles are added in an amount of 2 to 10 parts by weight based on 100 parts by weight of the external additive particles such as the above-mentioned hydrophobic silica particles or hydrophobic titanium oxide particles. Less than 2 parts by weight unfavorably gives no effects as a lubricant and a binder, whereas exceeding 10 parts by weight unfavorably leads to a reduction in fluidity and an increase in fogging.

The work function of the metal soap particles is within the range of 5.3 to 5.8 eV, and preferably approximately equivalent (the difference between absolute values within 0.15 eV, preferably within 0.1 eV) to that of the toner mother particles. As an external addition method, it is preferred to first externally add the hydrophobic silica particles to the toner mother particles, and then, to externally add the metal soap particles. The work function of the metal soap particle is preferably at least 0.2 eV larger than that of the hydrophobic monodisperse spherical silica particle. When the work function of the hydrophobic silica particles is from 5.0 to 5.3 eV, and the work function of the toner mother particles is from 5.25 to 5.8 eV, the external additive particles having a smaller work function are fixedly adhered to surfaces of the toner mother particles by charge transfer due to the difference in the work function. Then, the metal soap particles added in the after-process are adhered to the vicinities of the silica particles on the surfaces of the toner mother particles, or directly to the surfaces of the toner mother particles. However, by adjusting the work function of the toner mother particles to be approximately equivalent to that of the metal soap particles, it becomes possible to maintain the fluidity and chargeability of the toner mother particles without inhibiting the characteristics of giving the fluidity and chargeability, which are functions of the inorganic additive particles.

Further, addition of the metal soap particles having a work function approximately equivalent (the difference between absolute values is within 0.15 eV, preferably within 0.1 eV) to that of the toner mother particles can more decrease the number liberation rate of the external additive particles, and more prevent the occurrence of fogging. This is conceivably because charge transfer in the external additive particles is not inhibited. Further, the metal soap has a function as an adhesive between the toner mother particles and the external additive, so that the external additive can be prevented from being liberated from the toner mother particles.

As for the hydrophobic monodisperse spherical silica particles used in the invention, it is preferred that the large-sized and small-sized hydrophobic silica particles are first externally added to the toner mother particles, followed by external addition treatment with the metal soap particles. When the work function of the hydrophobic silica particles is from 5.0 to 5.3 eV, and the work function of the toner mother particles is from 5.25 to 5.8 eV, the large-sized and small-sized external additive particles having a smaller work function are fixedly adhered to the surfaces of the toner mother particles by charge transfer due to the difference in the work function. Further, the metal soap particles are added in the after-process, thereby being able to prevent liberation of the hydrophobic silica particles and to allow the above-mentioned functions caused by addition of the metal soap particles to be exhibited.

Further, when other external additive particles are used in combination as the external additive particles, for example, hydrophobic rutile/anatase type titanium oxide has a work function of 5.64 eV, and is preferably externally added together with the metal soap particles in the after-process. When the work function is approximately equivalent to that of the toner mother particles, direct adhesion to the toner mother particles becomes difficult. On the other hand, adhesion to the toner mother particles can be performed by the contact potential difference through the surfaces of the hydrophobic silica particles having a smaller work function.

The external additive is preferably added to the toner mother particles with a Henschel mixer (manufactured by Mitsui Miike Machinery Co., Ltd.), a mechanofusion system (manufactured by Hosokawa Micron Co., Ltd.) or Mechanomill (manufactured by Okada Seiko Co., Ltd.). When the Henschel mixer is used, it is preferably operated at 5,000 to 7,000 rpm for 1 to 3 minutes in addition of the hydrophobic silica particles in the first step, and it is preferably operated at 5,000 to 7,000 rpm for 1 to 3 minutes in addition of the metal soap particles in the second step.

The work function of the non-magnetic monocomponent negatively chargeable toner is preferably from 5.25 to 5.85 eV, and more preferably from 5.35 to 5.8 eV. When the work function of the toner is less than 5.25, the problem arises that the range of the available latent image carrier or intermediate transfer medium is narrowed. On the other hand, exceeding 5.85 eV means a decrease in the content of the colorant in the toner, posing the problem of deteriorated coloring properties. Among four color toners of yellow, magenta, cyan and black, the kinds of binder, colorant external additive and the like constituting the toner particles are appropriately selected within the above-mentioned work function range of the toner to adjust the work functions of the resulting toner particles. In this case, it is preferred that the work functions are at least 0.02 eV different from one another.

In the present invention, the intermediate transfer medium preferably has a work function (Φ_{TM}) smaller than that of a work function (Φ_{T}) of the non-magnetic monocomponent negatively chargeable spherical toner. Furthermore, the difference between the work function of the toner mother particle and that of the hydrophobic monodisperse spherical silica particle is preferably at least 0.2 eV, and the difference between the work function of the intermediate transfer medium and that of the non-magnetic monocomponent negatively chargeable spherical toner is preferably at least 0.2 eV.

In color superposition of the four color toners, the toner first developed or transferred is preferably a toner having the highest work function ranging from 5.6 to 5.8 eV, the second color toner superposed on the first color toner is preferably a toner having a work function of 5.5 to 5.7 eV, further, the third color toner superposed on the second color toner is preferably a toner having a work function of 5.4 to 5.6 eV, and finally, the fourth toner superposed on the third color toner is preferably a toner having a work function of 5.25 to 5.5 eV in the order of their decreasing work function. In particular, the first color toner is preferably a toner having a work function of at least 5.6 eV.

The non-magnetic monocomponent negatively chargeable spherical toner of the invention has a hardness of 7 to 19 MPa, and preferably 7.5 to 17 MPa, for the mechanical strength determined as a 10% displacement load from a test force-displacement graph obtained by using a micro-compression testing machine (“MCT-W500”, manufactured by Shimadzu Corporation) under the following conditions.

Set conditions in the measurement are as follows:
Upper pressure element: 50-μm diameter flat pressure element
Lower pressure plate: SKS flat plate
Load velocity: 0.17848 mN/sec
Room temperature: 25° C.
Humidity: 50%

Measurements are made 10 times or more for each toner particle, and a value is obtained as the arithmetical mean thereof. The 10% displacement load is obtained in an elastic compression region in a correlation curve obtained by plotting the load on the ordinate and the compression displacement on the abscissa. The elastic compression region is a region in which the toner is approximately linearly compressed with the load, and reversibly deformable by its elasticity without yielding by the load. When the mechanical strength determined as the 10% displacement load is less than 7 MPa, the external additive particles are embedded in the toner mother particles to deteriorate charge stability of the toner in continuous printing and to decrease the negative charge amount. However, the amount of a reversely charged toner increases to cause the problem of increased fogging and decreased transfer efficiency. On the other hand, exceeding 19 MPa results in the problem of the toner too hard and deteriorated fixing properties.

In the non-magnetic monocomponent negatively chargeable spherical toner of the invention, the number average molecular weight (Mn) as measured by gel permeation chromatography (GPC) based on polystyrene in a THF soluble is preferably from 1,500 to 20,000, more preferably from 2,000 to 15,000, and still more preferably from 3,000 to 12,000, at the stage of the toner mother particles or the toner particles subjected to external addition treatment. When the number average molecular weight (Mn) is lower than 1,500, the toner is excellent in low-temperature fixing properties, but inferior in retention of a colorant, filming resistance, offset resistance, fixed-image strength and storage stability. On the other hand, higher than 20,000 results in inferior low-temperature fixing properties. Further, the weight average molecular weight (Mw) is preferably from 3,000 to 300,000, and more preferably from 5,000 to 50,000. Mw/Mn is preferably from 1.5 to 20, and more preferably from 1.8 to 8.

Further, the flow softening temperature (Tf1/2) is preferably within the range of 100 to 120° C. When the flow softening temperature is lower than 100° C., high-temperature offset properties are deteriorated. On the other hand, higher than 120° C. results in inferior fixing strength at low temperature. Furthermore, the glass transition temperature (Tg) is prefaerably within the range of 55 to 70° C. When the glass transition temperature (Tg) is lower than 55° C., storage stability is deteriorated. On the other hand, when it is higher than 70° C., Tf1/2 is elevated therewith, resulting in inferior low-temperature fixing properties. The toner of the invention preferably has a melt viscosity at a 50% outflow point of 2×10³ to 1.5×10⁴ Pass, and can be suitable as a toner for oilless fixing.

In the full color image forming apparatus of the invention, the transfer efficiency can be enhanced by increasing the average sphericity of the non-magnetic monocomponent negatively chargeable spherical toner particles to 0.970 to 0.985, and it is possible to be made cleanerless. Further, when the work function (Φₜ) of the spherical toner, the work function (Φ_{OPC}) of the surface of the latent image carrier in the image forming apparatus and the work function (Φ_{TM}) of the intermediate transfer medium satisfy the relationship Φₜ>Φ_{OPC}>Φ_{TM}, the transfer efficiency can be excellent, and the amount of the transfer residual toner on the latent image carrier can be decreased.

Further, the work function (Φ_{TM}) of the surface of the intermediate transfer medium can be from 4.9 to 5.5 eV, and the work function of the non-magnetic monocomponent negatively chargeable spherical toner can be from 5.25 to 5.85 eV. However, in the full color image forming apparatus of the invention, the work function of the intermediate transfer medium is at least 0.2 eV smaller than the function work of the toner, thereby being able to decrease the amount of the transfer residual toner on the intermediate transfer medium after transfer to the recording member such as paper.

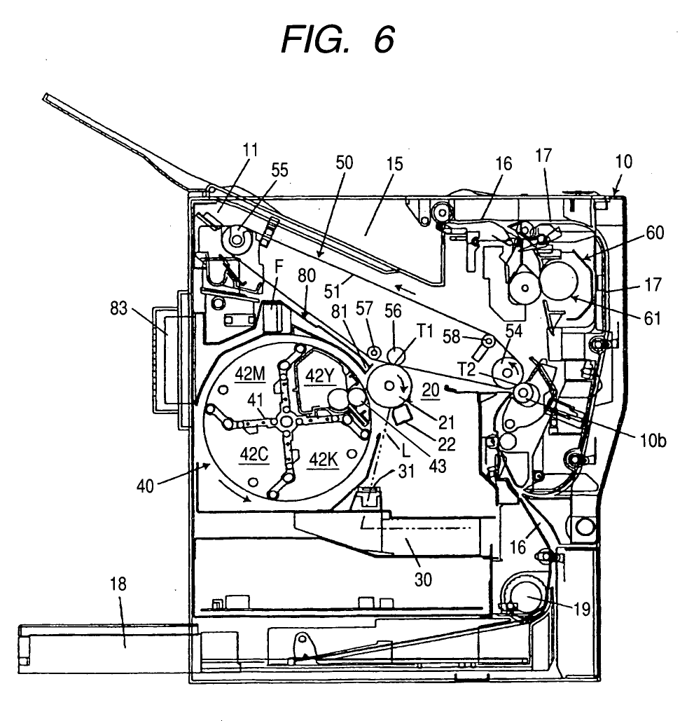

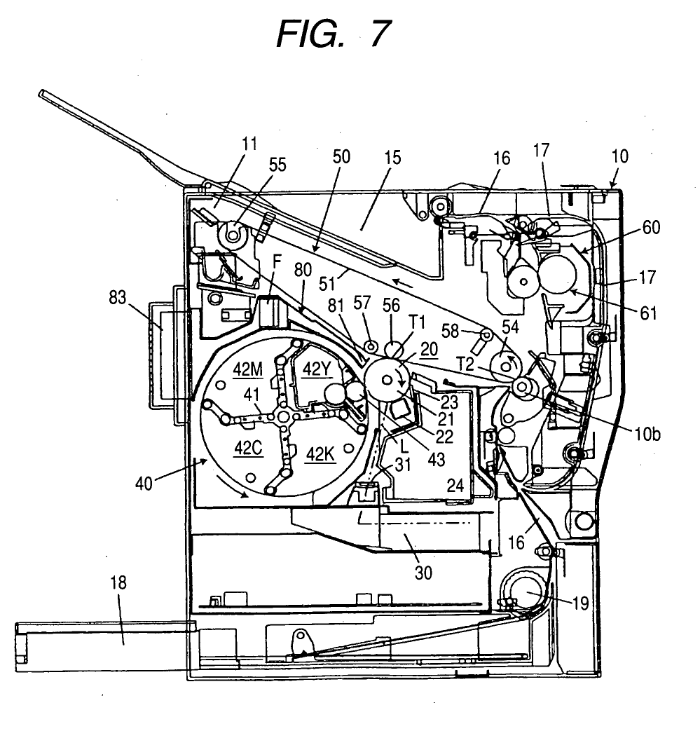

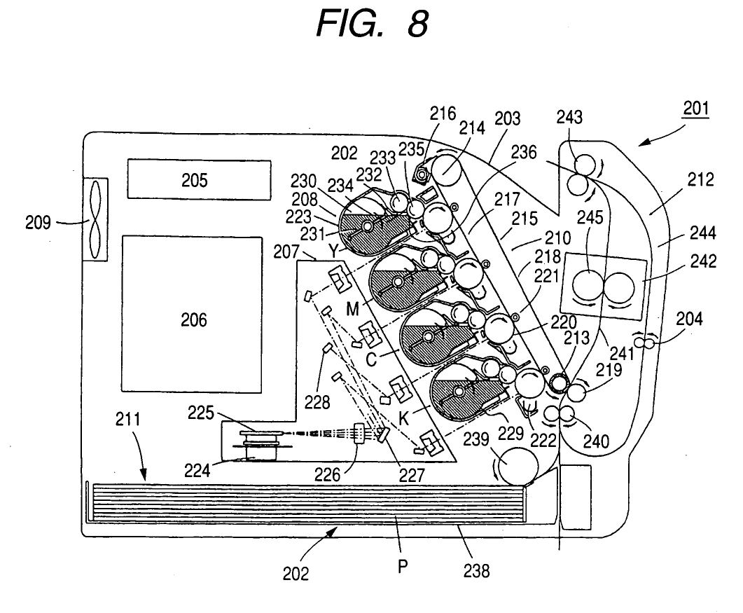

In an image forming apparatus shown in FIG. 6, when developing units using four color toners (developing agents) comprising yellow Y, cyan C, magenta M and black K are combined with a photoreceptor in a developing processes, a full color image forming apparatus is provided. FIG. 6 shows an embodiment of a full color printer of a rotary system according to the invention, and FIG. 7 shows a full color printer of a rotary system used for comparing cleaning amounts in Examples 1 and 2, in which a cleaning means is disposed on a latent image carrier. Further, FIG. 8 shows an embodiment of a tandem system.

In the present invention, each of the plurality of developing units preferably has a structure in which a toner storage member to which no toner is replenished is integrated with a developing member, and the developing member comprises a developing agent carrier and a toner layer regulating member for regulating a toner layer on the developing agent carrier into approximately one layer.

FIG. 6 is a view for illustrating a color image forming apparatus of a 4-cycle rotary developing system of a batch transfer system according to the invention. This image forming apparatus is a color image forming apparatus which can form full color images on both faces of a recording material such as paper, and comprises a case 10, an image carrier unit 20 contained in the case 10, an exposure unit 30 as an exposure means, a developer (developing device) 40 as a developing member, an intermediate transfer medium unit 50, and a fixing unit (fixer) 60 as a fixing means. The case 10 is provided with a frame (not shown) of a main body of the apparatus, and the respective units are attached to this frame.

The image carrier unit 20 has a latent image carrier (photoreceptor) 21 having a photosensitive layer on its peripheral surface, and a charging member (Scolotron charger) 22 for uniformly charging the peripheral surface of the photoreceptor 21. The peripheral surface of the photoreceptor 21 uniformly charged by the charging member 22 is selectively exposed to a laser beam L from the exposure unit 30 to form an electrostatic latent image. A toner as a developing agent is given to the electrostatic latent image in the developing device 40 to form a visible image (toner image). This toner image is primarily transferred at a primary transfer portion T1 to an intermediate transfer belt 51 of the intermediate transfer medium unit 50, and further secondarily transferred at a secondary transfer portion T2 to a paper sheet to which the image is to be transferred.

In the case 10, there are provided a delivery path 16 for delivering the paper sheet on one side of which the image is formed by the above-mentioned secondary transfer portion T2, toward a paper sheet discharge portion (delivery tray) 15 on an upper face of the case 10, and a return path 17 for returning the paper sheet delivered toward the paper sheet discharge portion 15 by the delivery path 16, through a switchback toward the above-mentioned secondary transfer portion T2 for forming an image on the other side. In a lower portion of the case 10, there are provided a paper feed tray 18 for holding a plurality of paper sheets stacked, and a paper feed roller 19 for feeding the paper sheets one by one toward the above-mentioned secondary transfer portion T2.

The developing device 40 is a rotary developing device, and a plurality of developing unit cartridges containing toners, respectively, are detachably mounted on a main body of rotation 41. In this embodiment, the developing unit cartridge 42Y for yellow, the developing unit cartridge 42M for magenta, the developing unit cartridge 42C for cyan and the developing unit cartridge 42K for black are mounted (in FIG. 6, only the developing unit cartridge 42Y for yellow is directly drawn). The main body of rotation 41 is rotated in the direction indicated by the arrow at 90 degree pitches, thereby allowing a developing roller 43 to selectively face to the photoreceptor 21, which makes it possible to selectively develop a surface of the photoreceptor 21.

The exposure unit 30 is constituted so that the above-mentioned laser beam L is irradiated from an exposure window 31 composed of plate glass to the photoreceptor 21.

The intermediate transfer medium unit 50 comprises a unit frame not shown, a driving roller 54 rotatably supported with this frame, a driven roller 55, a primary transfer roller 56, a guide roller 57 for stabilizing the state of a belt 51, a tension roller 58 and the above-mentioned intermediate transfer belt 51 laid around these rollers under tension, and the belt 51 is driven for circulation in the direction indicated by the arrow.

The above-mentioned primary transfer portion T1 is formed between the photoreceptor 21 and the primary transfer roller 56, and the above-mentioned secondary transfer portion T2 is formed at a position at which the driving roller 54 is brought into press contact with a secondary transfer roller 10b disposed on the main body side.

The secondary transfer roller 10b is detachably in contact with the above-mentioned driven roller 54 (therefore with the intermediate transfer belt 51), and when being in contact, the secondary transfer portion T2 is formed.

Accordingly, when a color image is formed, toner images of plural colors are superposed on the intermediate transfer belt 51 in a state where the secondary transfer roller 10b is detached from the intermediate transfer belt 51, thereby forming the color image. Then, the secondary transfer roller 10b is brought into abutting contact with the intermediate transfer belt 51, and the paper sheet is supplied to the abutting contact portion (secondary transfer portion T2), thereby transferring the color image (toner image) onto the paper sheet.

The paper sheet onto which the toner image has been transferred passes between a pair of heat rollers 61 of the fixing device 60, thereby melt-fixing the toner image, and is discharged to the above-mentioned the paper sheet discharge tray 15. The fixing device 60 is constituted by an oilless fixing device in which no oil is applied to the heat rollers 61.

Further, FIG. 7 is a view for illustrating a color image forming apparatus which is the same as the color image forming apparatus of a 4-cycle rotary developing system of a batch transfer system according to the invention, which is shown in FIG. 6, with the exception that a latent image carrier is provided with a cleaning means.

The color image forming apparatus of FIG. 7 is used for comparing cleaning amounts in Examples 1 and 2 described later, and the image carrier unit 20 is provided with a cleaning means (cleaning blade) 23 for removing the toner remaining on a surface of the photoreceptor 21 and a waste toner container 24 for containing a waste toner.

Then, FIG. 8 is a view for illustrating an embodiment of a color printer of a tandem system in the invention. The image forming apparatus 201 has no cleaning means on a latent image carrier, and comprises a housing 202, a delivery tray 203 formed the top of the housing 202, and a door body 204 attached to the front of the housing 202 so as to freely open and close. In the housing 202, there are arranged a control unit 205, a power source unit 206, an exposure unit 207, an image forming unit 208, an exhaust fan 209, a transfer unit 210 and a paper feed unit 211. In the door body 204, a paper transfer unit 212 is disposed. The respective units are constituted so as to be detachable with respect to the main body, and integrally detachable for repair or replacement at the time of maintenance.

The transfer unit 210 comprises a driving roller 213 disposed in a lower portion of the housing 202 and driven for rotation by a driving source (not shown), a driven roller 214 disposed diagonally above the driving roller 213 and an intermediate transfer belt 215 spanned around only these two rollers and driven for circulation in a direction indicated by an arrow (the counter-clockwise direction). The driven roller 214 and the intermediate transfer belt 215 are arranged in a direction oblique to the left with respect to the driving roller 213 in FIG. 8. This allows a belt-tensioned side (a side at which the belt is stretched with the driving roller 213) 217 of the intermediate transfer belt 215 in driving to be positioned downward, and a belt-loosen side 218 upward.

The driving roller 213 also serves as a backup roller for a secondary transfer roller 219 described later. A rubber layer having a thickness of about 3 mm and a volume resistance of 1×10⁵ Ω·cm or less is formed on a peripheral surface of the driving roller 213, and grounded through a metal shaft, thereby forming a conductive path of a secondary transfer bias supplied through the secondary transfer roller 219. As described above, the rubber layer having high friction and shock absorption is provided on the driving roller 213, whereby a shock at the time when a recording material enters a secondary transfer portion becomes difficult to be transmitted to the intermediate transfer belt 215. Thus, deterioration of image quality can be prevented.

Further, the diameter of the driving roller 213 is smaller than that of the driven roller 214, whereby it can be made easy to separate a recording paper after secondary transfer by elastic force of the recording paper itself.

Furthermore, a primary transfer member 221 is brought into abutting contact with the back of the intermediate transfer roller 215, opposite to latent image carriers 220 of respective unicolor image forming units Y, M, C and K constituting an image forming unit described later, and a transfer bias is applied to the primary transfer member 221.

The image forming unit 208 comprises the unicolor image forming units Y (for yellow), M (for magenta), C (for cyan) and K (for black) for forming a plurality of images (four images in this embodiment) different in color. Each of the unicolor image forming units Y, M, C and K has the latent image carrier 220 comprising a photoreceptor on which an organic photosensitive layer or an inorganic photosensitive layer is formed, and a charging member 222 comprising a corona charger and a developing member 223, which are arranged around the latent image carrier 220.

The latent image carrier 220 of each of the unicolor image forming units Y, M, C and K is arranged so as to be brought into abutting contact with the belt-tensioned side 217 of the intermediate transfer belt 215. As a result, each of the unicolor image forming units Y, M, C and K is also arranged in a direction oblique to the left with respect to the driving roller 213 in FIG. 8. The latent image carrier 220 is driven for rotation in the reverse direction to the rotational direction of the intermediate transfer belt 215, as indicated by arrows in FIG. 8.

The exposure unit 207 is disposed obliquely below the image forming unit 208, and has a polygon mirror motor 224, a polygon mirror 225, an f-θ lens 226, a reflection mirror 227 and a turn-back mirror 228 in the inside thereof. Image signals corresponding to the respective colors are formed by modulation based on the common data lock frequency, and then, radiated from the polygon mirror 225. The image carriers 220 of the respective unicolor image forming units Y, M, C and K are irradiated with the image signals through the f-θ lens 226, the reflection mirror 227 and the turn-back mirror 228 to form latent images. The length of light paths to the latent image carriers 220 of the respective unicolor image forming units Y, M, C and K is substantially adjusted to the same length by the action of the turn-back mirror 228.

Then, the developing member 223 will be described, taking the unicolor image forming unit Y as a representative example. In this embodiment, the respective unicolor image forming units Y, M, C and K are arranged in a direction oblique to the left in FIG. 8, so that toner storage containers 229 are arranged obliquely downward.

That is to say, the developing member 223 comprises the toner storage container 229 for storing the toner, a toner storage portion 230 (a hatched portion in FIG. 8) formed in the toner storage container 229, a toner stirring member 231 disposed in the toner storage portion 230, a partition member 232 formed for partition in an upper portion of the toner storage portion 230, a toner supply roller 233 disposed above the partition member 232, a charging blade 234 attached to the partition member 232 and brought into abutting contact with the toner supply roller 233, a developing roller 235 arranged so as to come close to the toner supply roller 233 and the latent image carrier 220, and a regulating blade 236 brought into abutting contact with the developing roller 235.

The developing roller 235 and the toner supply roller 233 driven for rotation in the reverse direction to the rotational direction of the latent image carrier 220, as indicated by arrows in FIG. 8. On the other hand, the stirring member 231 is driven for rotation in the reverse direction to the rotational direction of the toner supply roller 233. The toner stirred and carried up with the stirring member 231 in the toner storage portion 230 is supplied to the toner supply roller 233 along an upper surface of the partition member 232. The toner supplied is frictionally slid on the charging blade 234 made of a flexible material to cause adhesive force to uneven portions of a surface of the toner supply roller 233 by mechanical adhesive force and frictional charging force, thereby being supplied to a surface of the developing roller 235.

The toner supplied to the developing roller 235 is regulated to a thin layer having a specified thickness. The toner layer thinned is transferred to the latent image carrier 220, and the latent image on the latent image carrier 220 is developed in the developing region in which the developing roller 235 and the latent image carrier 220 are close to each other.

Further, at the time of image formation, the paper supply unit 211 is provided with a paper supply cassette 238 in which a plurality of recording materials S are held in a stacked state, and a pick-up roller 239 for feeding the recording materials S from the paper supply cassette 238, one by one.

The paper transfer unit 212 comprises a pair of gate rollers 240 (one of which is mounted on the side of the housing 202) for defining the paper supply timing of the recording material S to the secondary transfer portion, the secondary transfer roller 219 as a secondary transfer means which is brought into press contact with the driving roller 213 and the intermediate transfer belt 215, a main recording material conveying path 241, a fixing means 242, a pair of delivery rollers 243 and a double-sided print conveying path 244. After transfer to the recording material, a transfer residual toner remaining on the intermediate transfer belt 215 is removed with a cleaning means 216.

The fixing means 242 has a pair of freely rotatable fixing rollers 245 at least one of which contains a heating element such as a halogen heater, and a pressing means for pressing at least one of the pair of fixing rollers 245 to the other, whereby a secondary image which has been secondarily transferred to a sheet material is pressed to the recording material S. The secondary image secondarily transferred to the recording material is fixed to the recording material at a nip portion formed by the pair of fixing rollers 245 at a specified temperature.

The intermediate transfer belt 215 is arranged in a direction oblique to the left with respect to the driving roller 213 in FIG. 8, so that a wide space is generated on the right side. Accordingly, the fixing means 242 can be disposed in the space. It is therefore possible to realize miniaturization of the image forming apparatus and to prevent heat generated in the fixing means 242 from adversely affecting the exposure unit 207, the intermediate transfer belt 215 and the respective unicolor image forming units Y, M, C and K, which are positioned on the left side.

### EXAMPLES

The present invention is now illustrated in greater detail with reference to Examples and Comparative Examples, but it should be understood that the present invention is not to be construed as being limited thereto.

Preparation examples of respective members of image forming apparatuses used in the following respective examples and hydrophobic monodisperse spherical silica particles are shown below.

### Preparation of Organic Photoreceptor 1

A coating solution was prepared by dissolving and dispersing 6 parts by weight of alcohol-soluble nylon (CM8000, manufactured by Toray Industries, Inc.) and 4 parts by weight of fine titanium oxide particles treated with an aminosilane in 100 parts by weight of methanol. This coating solution was applied by a ring coating method onto an aluminum pipe 30 mm in diameter which was used as a conductive support, and dried at a temperature of 100° C. for 40 minutes, thereby forming an undercoat layer having a thickness of 1.5 to 2 μm.

A dispersion was prepared by dispersing 1 part by weight of an oxytitanium phthalocyanine pigment as a charge generating pigment and 1 part by weight of a butyral resin (BX-1, manufactured by Sekisui Chemical Co., Ltd.) in 100 parts by weight of dichloroethane for 8 hours in a sand mill having glass beads 1 mm in diameter. The resulting pigment dispersion was applied by the ring coating method, and dried at a temperature of 80° C. for 20 minutes, thereby forming a charge generation layer having a thickness of 0.3 μm.

A coating solution was prepared by dissolving 40 parts by weight of a charge transfer material of a styryl compound having the following structural formula (1) and 60 parts by weight of a polycarbonate resin (Panlite TS, manufactured by Teijin Chemicals Ltd.) in 400 parts by weight of toluene. The resulting solution was applied onto the charge generation layer by a dip coating method so as to give a dry thickness of 22 μm, and dried to form a charge transport layer, thereby preparing an organic photoreceptor (OPC1) comprising two layers.

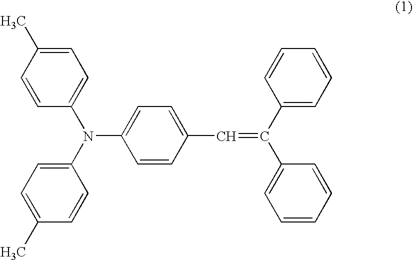

A part of the resulting organic photoreceptor was cut to prepare a test piece, and the work function thereof was measured with a surface analyzer (Type AC-2, manufactured by Riken Keiki Co., Ltd) at a dose of light of 500 nW. As a result, it showed 5.47 eV.

### Preparation of Organic Photoreceptor 2

An organic photoreceptor (OPC2) was prepared in the same manner as with the organic photoreceptor (OPC1) with the exception that the charge generation pigment was changed to titanium phthalocyanine, and the charge transfer material to a distyryl compound having the following structural formula (2). The work function of the organic photoreceptor (OPC2) was similarly measured. As a result, it was 5.50 eV.

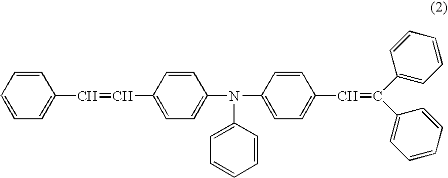

### Preparation Example of Developing Roller

A surface of an aluminum pipe 18 mm in diameter was subjected to blast treatment, and then, to electroless nickel plating (a thickness of 8 μm) to obtain a developing roller having a surface roughness (Rz) of 3 μm. The work function of the surface of this developing roller was measured under the same conditions as described above. As a result it was 4.58 eV.

### Preparation Example of Regulating Blade

A conductive polyurethane tip 1.5 mm in thickness was adhered to a stainless steel (SUS) plate 80 μm in thickness with a conductive adhesive, thereby preparing a regulating blade. The work function of the polyurethane surface measured under the same conditions as described above was 5.01 eV.

### Preparation Example of Intermediate Transfer Belt 1

A mixture obtained by preliminarily mixing 85 parts by weight of polybutylene terephthalate, 15 parts by weight of a polycarbonate, and 15 parts by weight of acetylene black by a mixer under a nitrogen gas atmosphere was subsequently kneaded by a twin-screw extruder under a nitrogen gas atmosphere, followed by palletizing. The pellets were extruded at a temperature of 260° C. by a single-screw extruder having an annular die to form a tubular film having an outer diameter of 170 mm and a thickness of 160 μm. Then, the extruded melt tube was defined in inner diameter with a cooling inside mandrel supported on the same axis as the annular die, and solidified by cooling to prepare a seamless tube. The seamless tube was cut to specified dimensions to obtain a seamless belt having an outer diameter of 172 mm, a width of 342 mm and a thickness 150 μm. This transfer belt had a volume resistance of 3.2×10⁸ Ω·cm.

The work function thereof was measured under the same conditions as described above. As a result, it was 5.19 eV. The standardized photoelectron yield was 10.88.

### Preparation Example of Intermediate Transfer Belt 2

A uniform dispersion prepared by using:
30 parts by weight of a polyvinyl chloride-vinyl acetate copolymer;
10 parts by weight of an electroconductive carbon black; and
70 parts by weight of methyl alcohol
was applied on a polyethylene telephthalate resin film on which aluminum was deposited by vapor deposition and having a thickness of 130 mm by a roll coating method followed by drying to achieve a film thickness of 20 mm, thereby obtaining an intermediate electroconductive layer.

Then, on the thus-obtained intermediate electroconductive layer, a coating liquid obtained by mixing dispersion of a composition containing:
55 parts by weight of a nonionic water based urethane resin (solid content: 62 wt %);
11.6 parts by weight of a polytetrafluoroethylene emulsion resin (solid content: 60 wt %);
5 parts by weight of electroconductive titanium oxide;
25 parts by weight of electroconductive tin oxide;
34 parts by weight of polytetrafluoroethylene fine particles (max particle system: 0.3 μm or less);
5 parts by weight of polyethylene emulsion (solid content: 35 wt %); and

20 parts by weight of ion exchange water

was applied by the roll coating method followed by drying to achieve a film thickness of 10 μm, thereby forming a transfer layer.

The resulting coated sheet was cut to a length of 540 mm, and both ends were overlapped with each other and welded by ultrasonic welding with the coated surface facing upward, thereby preparing an intermediate transfer medium (transfer belt). The volume resistance of this transfer belt was 8.8×10⁹ Ω·cm. Further, the work function thereof showed 5.69 eV, and the standardized photoelectron yield showed 7.39.

### Preparation Example of Spherical Silica Particles 1

Spherical silica particles 1 were prepared in accordance with a method described in JP 7-91440 B. In a 1-liter glass reactor equipped with a stirrer, a drop inlet and a thermometer, 750 ml of cyclohexane, 33 g of polyethylene glycol nonyl phenyl ether and 30 g of a 28% ammonia aqueous solution were placed, and mixed. The resulting mixed solution was kept at 30° C., and 42 g of tetraethoxysilane and 5.5 g of diacetoxydimethylsilane were added dropwise thereto with stirring from the drop inlet, taking 10 minutes. After dropping, stirring was further continued for 2 hours, and hydrolysis was performed to obtain a suspension. The suspension was transferred to a evaporator, and placed under reduced pressure at an evaporator temperature of 40° C. to remove ammonia, water and cyclohexane, thereby obtaining fine powdery silica particles. The resulting fine silica particles were observed under a scanning electron microscope (S-4800, manufactured by Hitachi, Ltd.). As a result, they were fine spherical silica particles having a number average primary particle size of 100 nm and a particle size range of 78 to 123 nm. The work function thereof was 5.07 eV.

### Preparation Example of Spherical Silica Particles 2

With a mixed solution of 150 ml of toluene and 60 ml of ethyl acetate, 0.6 g of dimethyl silicone was mixed, and homogeneously dispersed by ultrasonic dispersion (Model US-300T, manufactured by Nippon Seiki Seisakusho K.K.) for 1 minute. Then, 9 g of monodisperse spherical silica particles 1 obtained above was added, and ultrasonic dispersion was further performed for 3 minutes, followed by filtration under reduced pressure and drying at 65° C. for 5 hours. After drying, the resulting product was pulverized by using a blender (COMMERCIAL LABORATORY BLENDER, manufactured by WARING Co.) to obtain hydrophobic monodisperse spherical silica particles having a BET specific surface area of 10.7 m²/g. The resulting fine silica particles were observed under a scanning electron microscope (S-4800, manufactured by Hitachi, Ltd.). As a result, they were fine hydrophobic monodisperse spherical silica particles having a number average primary particle size of 100 nm and a particle size range of 79 to 124 nm. The work function thereof was 5.20 eV.

### Preparation Example of Spherical Silica Particles 3

Hydrophobic monodisperse spherical silica particles having a BET specific surface area of 9.8 m²/g were obtained in the same manner as with the preparation example of hydrophobic monodisperse spherical silica particles 2 with the exception that amino-modified silicone oil (“KF-868”, manufactured by Shin-Etsu Silicone Co., Ltd.) was substituted for dimethyl silicone. The resulting fine silica particles were observed under a scanning electron microscope (S-4800, manufactured by Hitachi, Ltd.). As a result, they were fine hydrophobic monodisperse spherical silica particles having a number average primary particle size of 100 nm and a particle size range of 75 to 130 nm. The work function thereof was 5.62 eV.

Hereinafter, Examples 1 and 2 illustrate the performance of the non-magnetic monocomponent negatively chargeable spherical toner of the invention using the image forming apparatus in which the latent image carrier is provided with the cleaning means, and Example 3 and later illustrate the non-magnetic monocomponent negatively chargeable spherical toner and full color image forming apparatus of the invention.

### Example 1

### Preparation of Cyan Toner Mother Particles 1

A hundred parts by weight of a 50:50 (weight ratio) mixture (Himer ES-803, manufactured by Sanyo Chemical Industries, Ltd.) of a polycondensation polyester resin of an aromatic dicarboxylic acid and alkylene-etherified bisphenol A and a partially crosslinked product of the polycondensation polyester resin with a polyvalent metal compound, 5 parts by weight of a cyan pigment (Pigment Blue 15:1), 4 parts by weight of a release agent (carnauba wax, melting point: 80 to 86° C.) and 4 parts by weight of a charge control agent (“salicylic acid metal complex E-81”, manufactured by Orient Chemical Industries, Ltd.) were homogeneously mixed by using a Henschel mixer, and then kneaded by a twin-screw extruder with an internal temperature of 130° C., followed by cooling.

Then, the cooled matter was roughly pulverized to pieces of 2 mm square or less, and 100 parts by weight of this roughly pulverized matter was stirred in a mixed organic solvent solution of 150 parts by weight of toluene and 100 parts by weight of ethyl acetate to prepare a uniformly mixed oil-phase dispersion. The viscosity of this dispersion was 67 mP·s at 25° C.

Then, 5 parts by weight of a fine powder of tricalcium phosphate (previously pulverized in a ball mill, and confirmed to contain no particles having a particle size of 3 μm or more) and 5 parts by weight of a 1% by weight aqueous solution of sodium dodecylbenzenesulfonate were added to 1100 parts by weight of ion exchanged water, followed by stirring to prepare a uniformly mixed aqueous-phase dispersion.

In granulation, the above-mentioned aqueous-phase dispersion was first transmitted to a vessel equipped with a blowout unit of a porous glass (pore size: 3 μm, manufactured by SPG Technology Co., Ltd.), a stirring blade and an ultrasonic element as shown in FIG. 5A, and stirred at 10 revolutions per minute. Then, stirring was continued while forcing the above-mentioned oil-phase dispersion into a pipe directly connected to the blowout unit composed of the porous glass in the vessel at a pressure of 14.7×10⁴ Pa (in the direction indicated by the open arrow above the vessel).

In this case, voltage was applied to an ultrasonic homogenizer (Model US-300T, manufactured by Nippon Seiki Seisakusho K.K., output: 300 W, vibrator diameter: 26 mm) fixed to an upper portion of the vessel, and a current of 100 μA was allowed to flow to perform previous vibration so as to prevent fine emulsion particles formed from being united. At a vibration of 20 kHz, the amplitude is vertical, and a value of 30 μm can be maintained for 400 μA and a value of 10 μm for 100 μA. However, a vertical amplitude of 10 μm was imparted for a current of 100 μA in this example. Also after the termination of forcing the aqueous-phase dispersion into the pipe, stirring was continued for 10 minutes in a rotational direction as indicated by the solid arrow in FIG. 5A.

Then, the emulsion thus formed was taken out from a bottom 9 of the vessel, and transmitted to a stirring tank separately prepared. Thereafter, the temperature thereof was kept at 50° C. or higher with further stirring to remove the organic solvents contained therein. Then, the emulsion was repeatedly washed with 5 N hydrochloric acid, washed with water and filtered, and dried to obtain cyan toner mother particles 1.

The number average primary particle size and sphericity of the resulting cyan toner mother particles were measured with a flow type particle image analyzer (FPIA-2100, manufactured by Sysmex Corporation). The number-based number average primary particle size was 6.5 μm, and the sphericity was 0.980. Further, the work function measured at a dose of light of 500 nW was 5.25 eV.

### Preparation of Cyan Toner Mother Particles A, B and C for Comparison

Cyan toner mother particles A, B and C for comparison were each prepared in the same manner as with the preparation of the toner mother particles of Example 1 with the exception that 4 parts by weight of carnauba wax was substituted by 8 parts by weight, 10 parts by weight and 12 parts by weight of carnauba wax, respectively, and the average primary particle size, sphericity and work function thereof were similarly measured. The results thereof are shown in the following Table 1.

TABLE 1

| Cyan Toner Mother | Average Primary | | Work Function |
|---|---|---|---|
| Particles | Particle Size (μm) | Sphericity | (eV) |
| A | 6.3 | 0.978 | 5.26 |
| B | 6.2 | 0.979 | 5.30 |
| C | 6.3 | 0.981 | 5.32 |

Then, to 100 parts by weight of each of the resulting cyan toner mother particles 1 and cyan toner mother particles A, B and C, 0.8% by weight of hydrophobic silica particles (work function: 5.22 eV) having an average primary particle size of 12 nm as a fluidity improving agent, and 0.5% by weight of spherical hydrophobic silica particles (work function: 5.20 eV) having an average primary particle size of 100 nm and a particle size range of 79 to 124 nm were added and mixed. Then, 0.5% by weight of hydrophobic titanium oxide (work function: 5.64 eV) having an average primary particle size of 20 nm and 0.1% by weight of calcium stearate particles (work function: 5.32 eV) having an average primary particle size of 1.2 μm were added and mixed to prepare cyan toner 1 of Example 1 and cyan toners A, B and C for comparison, respectively.

The mechanical strength of the respective toners thus obtained was determined as a 10% displacement load by using a micro-compression testing machine (“MCT-W500”, manufactured by Shimadzu Corporation), and the work function was also similarly determined. The results thereof are shown in Table 2. Measuring conditions were as follows:
Upper pressure element: 50-μm diameter flat pressure element
Lower pressure plate: SKS flat plate
Load velocity: 0.17848 mN/sec
Room temperature: 25° C.
Humidity: 50%

Each toner thus prepared was loaded in each developing cartridge for cyan toner of a full color printer of a 4-cycle rotary system having a cleaning means on a latent image carrier as shown in FIG. 7, and continuous printing tests for evaluating durability were conducted. As the latent image carrier, there was employed the organic photoreceptor (OPC1) prepared above. Further, as a developing roller and a regulating blade, there were employed the developing roller and regulating blade prepared above. Furthermore, as an intermediate transfer medium, there was employed the intermediate transfer belt 1 prepared above.

As for an evaluation method, a manuscript corresponding a 5% color manuscript for cyan color was continuously printed on 5,000 sheets of paper, and the charge characteristics of the toner on the developing roller before and after durability evaluation were measured with a charge distribution measuring device (“E-SPART III”, manufactured by Hosokawa Micron Corporation), and the results thereof are shown in Table 3.

The image formation in that case was conducted by the non-contact developing process as shown in FIG. 1. The developing gap was set to 170 μm, and the developing bias was adjusted by patch control so that the developing toner amount on the organic photoreceptor became about 0.55 mg/cm². The frequency of alternating current superimposed on direct current was 2.5 kHz, and the peak-to-peak voltage was 1300 V. The amount of the regulated toner on the developing roller was adjusted so as to be about 0.42 mg/cm². For the transfer voltage of the primary transfer portion, +450 V was applied.

TABLE 2

| | Work | |
|---|---|---|
| | Function | Mechanical Strength at 10% |
| Cyan Toner | (eV) | Displacement Load (MPa) |
| Cyan Toner 1 (Invention) | 5.27 | 9.051 |
| Cyan Toner A (Comparison) | 5.30 | 6.622 |
| Cyan Toner B (Comparison) | 5.34 | 4.358 |
| Cyan Toner C (Comparison) | 5.35 | 3.325 |

TABLE 3

| | | | Number % of | |
|---|---|---|---|---|
| | | | Reversely | |
| | Negative Charge | | Charged + Toner | |
| | Amount (μc/g) | | Particles | |
| | | After Durability | | After Durability |
| | Initial | Evaluation | Initial | Evaluation |
| Cyan Toner 1 | −11.52 | −11.11 | 1.6 | 2.5 |
| (Invention) | | | | |
| Cyan Toner A | −11.15 | −10.09 | 2.7 | 5.1 |
| (Comparison) | | | | |
| Cyan Toner B | −10.23 | −8.26 | 4.9 | 7.8 |
| (Comparison) | | | | |
| Cyan Toner C | −9.56 | −6.37 | 6.3 | 10.6 |
| (Comparison) | | | | |

As apparent from Tables 2 and 3, it is shown that the negative charge amount decreases and the reversely charged+toner amount increases, with a decrease in mechanical strength at a 10% displacement load. Considering together with the results of Table 1, in the case of high sphericity, when the mechanical strength of the toner mother particles is as low as 7 MPa or less, the external additive is embedded to change the charge characteristics of the toner in continuous printing, resulting in a decrease in negative charge amount and an increase in reversely charged+toner amount. This is presumed to cause an increase in fogging and a decrease in transfer efficiency.

Accordingly, the amount of the toner cleaned by the cleaning means on the latent image carrier (organic photoreceptor) after the above-mentioned continuous printing of 5,000 sheets was measured, and the results thereof are shown in Table 4, together with the mechanical strength at a 10% displacement load, again.

TABLE 4

| | Mechanical | Cleaning |
|---|---|---|
| | Strength at | Toner |
| | 10% Displacement | Amount |
| Cyan Toner | Load (MPa) | (g) |
| Cyan Toner 1 (Invention) | 9.051 | 8 |
| Cyan Toner A (Comparison) | 6.622 | 21 |
| Cyan Toner B (Comparison) | 4.358 | 30 |
| Cyan Toner C (Comparison) | 3.325 | 36 |

As apparent form Table 4, it is shown that the toner having a value of 7 MPa or more as the mechanical strength at a 10% displacement load is preferably used, in order to make the latent image carrier cleanerless. When the mechanical strength of the toner is low, the external additive particles are embedded to lead to an increase in fogging and an increase in transfer residual toner amount, as apparent from Table 4. This is caused by the amount of the + toner which is reverse in polarity to the charge polarity of the latent image carrier.

Using cyan toner 1 of Example 1 and cyan toner C for comparison, dot reproducibility (dot diameter: 42 μm) was compared. The results thereof are shown in FIGS. 9A and 9(b). FIG. 9A indicates the development with cyan toner 1 of Example 1, and FIG. 9(b) indicates the development with cyan toner C for comparison. Cyan toner C in which the mechanical strength at a 10% displacement load of the toner mother particles was 3.325 MPa caused the occurrence of inter-dot fogging to give inferior results for reproducibility of halftone image quality. This reveals that the mechanical strength at a 10% displacement load is required to be 7 MPa or more for reproduction of halftone image quality.

### Example 2

Cyan toner mother particles 2, 3 and 4 were each prepared in the same manner as with Example 1 with the exception that 40:60, 30:70 and 20:80 (weight ratio) mixtures (manufactured by Sanyo Chemical Industries, Ltd.) of a polycondensation polyester resin of an aromatic dicarboxylic acid and alkylene-etherified bisphenol A and a partially crosslinked product of the polycondensation polyester resin with a polyvalent metal compound were each used as the binder resin in the toner mother particles of Example 1.

For the cyan toner mother particles prepared, the number-based average primary particle size, sphericity and work function were measured in the same manner as with Example 1. The results thereof are shown in Table 5.

TABLE 5

| | Average Primary | | Work Function |
|---|---|---|---|
| Toner Mother Particles | Particle Size (μm) | Circularity | (eV) |
| Cyan Toner | 6.3 | 0.979 | 5.27 |
| Mother Particles 2 | | | |
| Cyan Toner | 6.5 | 0.980 | 5.28 |
| Mother Particles 3 | | | |
| Cyan Toner | 6.2 | 0.980 | 5.28 |
| Mother Particles 4 | | | |

Then, to 100 parts by weight of each of the resulting cyan toner mother particles, 0.8% by weight of hydrophobic silica particles (work function: 5.22 eV) having an average primary particle size of 12 nm as a fluidity improving agent and 5% by weight of spherical hydrophobic silica particles (work function: 5.20 eV) having an average primary particle size of 100 nm and a particle size range of 79 to 124 nm were added and mixed. Then, 0.5% by weight of hydrophobic titanium oxide (work function: 5.64 eV) having an average primary particle size of 20 nm and 0.1% by weight of calcium stearate particles (work function: 5.32 eV) having an average primary particle size of 1.2 μm were added and mixed to prepare cyan toners 2, 3 and 4, respectively. Further, cyan toner mother particles 1 obtained in Example 1 were subjected to external addition treatment in the same manner as described above to prepare cyan toner 1′.

The work function and mechanical strength of the respective toners thus obtained were measured in the same manner as with Example 1. The results thereof are shown in Table 6.

In the same manner as with Example 1, each toner thus prepared was loaded in each developing cartridge for cyan toner of a full color printer of a 4-cycle rotary system having a cleaning means on a latent image carrier as shown in FIG. 7, and continuous printing tests for evaluating durability were conducted. A halftone manuscript of 30% duty at the time when the temperature of the fixing unit was set to 190° C., and the printing speed to 40 sheets/minute was printed, and fixed onto paper (J paper).

The half fixing rate of a fixed image was determined by rubbing a surface of the fixed halftone image back and forth 20 times with a 200 g weight wrapped with gauze under load, measuring the toner image density before and after rubbing by using a reflective densitometer, and indicating (decreased density)/(initial density) in percentage. The results thereof are shown in Table 6.

TABLE 6

| | Work | | |
|---|---|---|---|
| | Function | Mechanical Strength at 10% | Half Fixing |
| Cyan Toner | (eV) | Displacement Load (MPa) | Rate (%) |
| Cyan Toner 1′ | 5.42 | 9.051 | 89.3 |
| Cyan Toner 2 | 5.70 | 11.410 | 83.1 |
| Cyan Toner 3 | 5.51 | 13.251 | 72.6 |
| Cyan Toner 4 | 5.41 | 18.777 | 65.9 |

In the case of a half fixing rate of 60% or less, when the fixed image is rubbed with a finger, the finger is sometimes stained, resulting in substantially unfavorable print quality. As apparent from Table 6, it is proved that the mechanical strength at a 10% displacement load is preferably 19 MPa or less.

### Example 3

In Example 1, 10 parts by weight of Pigment Blue 15:1 as a cyan pigment and 2 parts by weight of a 50:50 (weight ratio) mixture (Himer ES-803, manufactured by Sanyo Chemical Industries, Ltd.) of a polycondensation polyester resin of an aromatic dicarboxylic acid and alkylene-etherified bisphenol A and a partially crosslinked product of the polycondensation polyester resin with a polyvalent metal compound were mixed and pulverized together with 50 parts by weight of toluene in a ball mill for 3 hours. After mixing and pulverization, the resulting product was filtered and air-dried to obtain the cyan pigment surface treated with the polyester resin.

Cyan toner mother particles 5 were prepared in the same manner as with Example 1 with the exception that 5.5 parts by weight of this pigment was used.

Further, magenta toner mother particles 1, yellow toner mother particles 1 and black toner mother particles 1 were each prepared in the same manner as with Example 1 with the exception that Carmine 6B as a magenta pigment, Pigment Yellow 180 as a yellow pigment and carbon black as a black pigment were each used in place of the cyan pigment in Example 1.

For cyan toner mother particles 5, magenta toner mother particles 1, yellow toner mother particles 1 and black toner mother particles 1, the number-based average primary particle size, sphericity and work function were measured in the same manner as with Example 1. The results thereof are shown in Table 7.

TABLE 7

| | Average Primary | | Work Function |
|---|---|---|---|
| Toner Mother Particles | Particle Size (μm) | Circularity | (eV) |
| Cyan Toner | 6.4 | 0.981 | 5.41 |
| Mother Particles 5 | | | |
| Magenta Toner | 6.6 | 0.980 | 5.69 |
| Mother Particles 1 | | | |
| Yellow Toner | 6.5 | 0.981 | 5.50 |
| Mother Particles 1 | | | |
| Black Toner | 6.6 | 0.980 | 5.40 |
| Mother Particles 1 | | | |

Then, to 100 parts by weight of each of the resulting cyan toner mother particles, 0.8% by weight of hydrophobic silica particles (work function: 5.22 eV) having an average primary particle size of 12 nm as a fluidity improving agent and 0.3% by weight of spherical hydrophobic silica particles (work function: 5.20 eV) having an average primary particle size of 100 nm and a particle size range of 79 to 124 nm were added and mixed. Then, 0.5% by weight of hydrophobic titanium oxide (work function: 5.64 eV) having an average primary particle size of 20 nm and 0.1% by weight of magnesium stearate particles (work function: 5.58 eV) having an average primary particle size of 1.1 μm were added and mixed to prepare cyan toner 5, magenta toner 1, yellow toner 1 and black toner 1, respectively. The work function and mechanical strength at a 10% displacement load of the respective toners are shown in the following Table 8.

Each toner thus prepared was loaded in each corresponding developing cartridge of a full color printer of a 4-cycle system in which a cleaning means was detached from a latent image carrier as shown in FIG. 6, and continuous printing tests were conducted. At this time, a slight amount of transfer residual toner on a surface of the latent image carrier was controlled so as to be negatively charged with a Scolotron charger, transferred to an intermediate transfer belt and subjected to cleaning on the intermediate transfer belt. As the intermediate transfer belt, there was used the intermediate transfer medium 1 prepared above, similarly to FIG. 7.

Development was performed by a non-contact developing system in the order of increasing work function of the toners, from an upstream side of a direction in which the intermediate transfer belt advanced, that is to say, in the order of magenta toner 1, yellow toner 1 and cyan toner 5, and black toner 1 was set to be used first as the development order.

Further, image forming conditions at this time were the same as with Example 1. The power source of the primary transfer portion was constant voltage controlled, and +500 V was applied. The power source of the secondary transfer portion was constant current controlled.

The image of N-2A “cafeteria” of the standard image data based on JIS X 9201-1995 was continuously printed on 2,000 sheets, and then the amount of the toner cleaned by the cleaning means on the intermediate transfer belt was measured.

Furthermore, the amount of the toner cleaned in the same manner as described above with the exception that the image was continuously printed using the intermediate transfer belt 2 in place of the intermediate transfer belt 1 was measured. The results thereof are shown in Table 8.

TABLE 8

| | | Mechanical | | |
|---|---|---|---|---|
| | | Strength | Cleaning Toner Amount (g) | |
| | Work | at 10% | Intermediate | Intermediate |
| | Function | Displacement | Transfer Belt 1 | Transfer Belt 2 |
| Toner | (eV) | Load (MPa) | Φ = 5.19 eV | Φ = 5.69 eV |
| Cyan 5 | 5.42 | 9.108 | 25 | 41 |
| Toner | | | | |
| Magenta | 5.70 | 9.935 | | |
| Toner 1 | | | | |
| Yellow | 5.51 | 9.095 | | |
| Toner 1 | | | | |
| Black | 5.41 | 9.203 | | |
| Toner 1 | | | | |

As apparent from Table 8, in the image forming apparatus in which no cleaning means is provided on the latent image carrier, it is proved that the transfer residual toner amount on the intermediate transfer belt after transfer to paper can be decreased by using the toner having a mechanical strength at a 10% displacement load of 7 MPa or more and making the work function of the intermediate transfer belt smaller than that of the toner.

### Example 4

To 100 parts by weight of each of the toners described in Table 7 in Example 3, 0.8% by weight of hydrophobic silica particles (work function: 5.22 eV) having an average primary particle size of 12 nm as a fluidity improving agent, 0.2% by weight of hydrophobic silica particles (work function: 5.24 eV) having an average primary particle size of 40 nm and 0.4% by weight of the spherical silica particles 2 with an average primary particle size of 100 nm and a particle size range of 79 to 124 nm obtained above were added and mixed. Then, 0.5% by weight of hydrophobic titanium oxide (work function: 5.64 eV) having an average primary particle size of 20 nm, 0.2% by weight of amorphous titanium oxide (work function: 5.41 eV) having a primary particle size ranging from 0.3 to 0.6 μm as measured under a scanning electron microscope and 0.1% by weight of magnesium stearate particles (work function: 5.32 eV) having an average primary particle size of 1.2 μm were added and mixed to prepare cyan toner 6, magenta toner 2, yellow toner 2 and black toner 2, respectively.

Further, cyan toner 7, magenta toner 3, yellow toner 3 and black toner 3 were each prepared in the same manner as described above with the exception that the spherical silica particles 1 prepared above were used in place of the spherical silica particles 2.

Further, cyan toner 8, magenta toner 4, yellow toner 4 and black toner 4 were each prepared in the same manner as described above with the exception that the spherical silica particles 3 prepared above were used in place of the spherical silica particles 2.

The work function and mechanical strength at a 10% displacement load of the respective toners thus obtained are shown in the following Table 9. Each toner thus prepared was loaded in a cyan developing unit of a tandem color printer in which a cleaning means was detached from a latent image carrier as shown in FIG. 8, and white solid printing was performed. Then, the charge characteristics of the toner on the developing roller were determined by using a charge distribution measuring device (“E-SPART III”, manufactured by Hosokawa Micron Corporation), and the results thereof are shown in Table 10.

TABLE 9

| | | Kind of | Mechanical |
|---|---|---|---|
| | | Spherical | Strength |
| | Work | Silica And | at 10% |
| | Function | Work | Displacement |
| Cyan Toner | (eV) | Function (eV) | Load (MPa) |
| Cyan Toner 6 | 5.41 | Silica particles 1 | 9.111 |
| Magenta Toner 2 | 5.68 | 5.07 | 9.330 |
| Yellow Toner 2 | 5.50 | | 9.015 |
| Black Toner 2 | 5.40 | | 9.198 |
| Cyan Toner 7 | 5.42 | Silica particles 2 | 9.110 |
| Magenta Toner 3 | 5.69 | 5.20 | 9.340 |
| Yellow Toner 3 | 5.52 | | 9.131 |
| Black Toner 3 | 5.42 | | 9.251 |
| Cyan Toner 8 | 5.43 | Silica particles 3 | 9.109 |
| Magenta Toner 4 | 5.71 | 5.62 | 9.337 |
| Yellow Toner 4 | 5.53 | | 9.104 |
| Black Toner 4 | 5.43 | | 9.213 |

TABLE 10

| | Negative Charge | Number % of Reversely |
|---|---|---|
| Cyan Toner | Amount (μc/g) | Charged + Toner Particles |
| Cyan Toner 6 | −11.2 | 2.3 |
| Magenta Toner 2 | −11.9 | 1.3 |
| Yellow Toner 2 | −12.1 | 2.9 |
| Black Toner 2 | −10.7 | 2.9 |
| Cyan Toner 7 | −11.2 | 2.2 |
| Magenta Toner 3 | −11.9 | 1.1 |
| Yellow Toner 3 | −12.1 | 2.6 |
| Black Toner 3 | −10.7 | 2.3 |
| Cyan Toner 8 | −8.3 | 10.0 |
| Magenta Toner 4 | −8.1 | 11.3 |
| Yellow Toner 4 | −7.7 | 12.1 |
| Black Toner 4 | −6.9 | 11.8 |

As apparent from Tables 9 and 10, when the work function of the spherical silica particles is larger than that of the toner, not only the charge amount decreases, but also the + toner amount which is reverse in polarity increases. This proves that the occurrence of fogging and a decrease in transfer efficiency are brought about thereby.

Then, each toner thus prepared was loaded in each corresponding developing cartridge of a tandem color printer in which a cleaning means was detached from a latent image carrier as shown in FIG. 8, and continuous printing tests were conducted. Development was performed by a non-contact developing system in the order of increasing work function of the toners, from an upstream side of a direction in which the intermediate transfer belt advanced, that is to say, in the order of the magenta toner, the yellow toner, the cyan toner and the black toner. However, printing was made possible even when the black toner was used first or last. When the order of development was changed, the order of image treatment was changed.

As the latent image carrier, there was employed the organic photoreceptor (OPC2) prepared above. As a developing roller and a regulating blade, there were employed the developing roller and regulating blade prepared above. Further, as an intermediate transfer medium, there was employed the intermediate transfer belt 1 prepared above.

For image forming conditions, the developing gap was set to 200 μm, and the developing bias was adjusted so that the developing toner amount per color on the organic photoreceptor was inhibited up to 0.55 mg/cm² by patch control. The frequency of alternating current superimposed on direct current was 2.5 kHz, and the peak-to-peak voltage was 1400 V. The amount of the regulated toner on the developing roller was adjusted so as to be about 4.2 mg/cm². The power source of the primary transfer portion was constant voltage controlled, and +500 V was applied. The power source of the secondary transfer portion was constant current controlled.

The image of N-2A “cafeteria” of the standard image data based on JIS X 9201-1995 was continuously printed on 1,000 sheets. As a result, when cyan toner 8, magenta toner 4, yellow toner 4 and black toner 4 were used, the hysteresis of the transfer residual toner was observed on a printed image from the second sheet. It was therefore impossible to make the latent image carrier cleanerless.

### Example 5

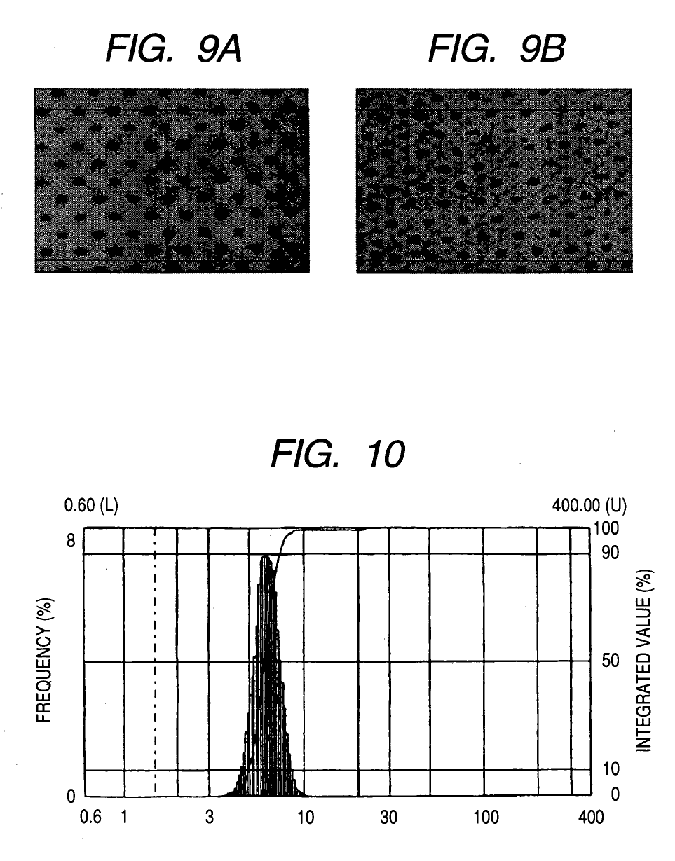

Cyan toner mother particles 9 were prepared in the same manner as with cyan toner mother particles 1 in Example 1 with the exception that the amount of carnauba wax added was changed to 3 parts by weight. For the resulting cyan toner mother particles 9, the number-based particle size distribution measured with a flow type particle image analyzer (FPIA-2100) is shown in FIG. 10. Cyan toner mother particles 9 had a number-based average primary particle size of 6.3 μm, a sphericity of 0.980 and a work function of 5.23 eV.

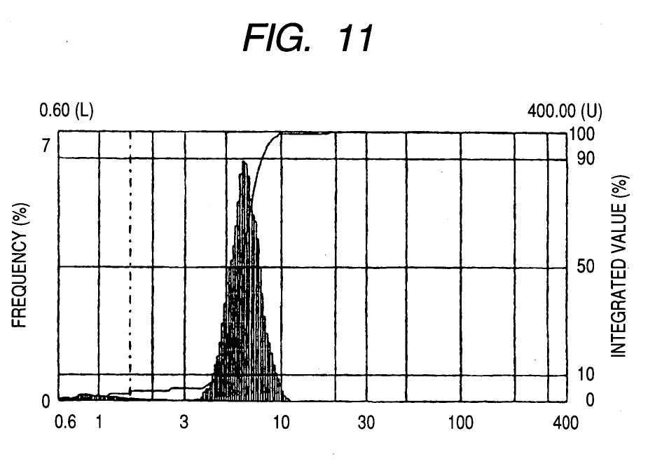

Further, cyan toner mother particles D for comparison was prepared in the same manner as with Example 1 with the exception that the ultrasonic element was not actuated in granulation of cyan toner mother particles 1. For the resulting cyan toner mother particles D, the number-based particle size distribution measured with a flow type particle image analyzer (FPIA-2100) is shown in FIG. 11. Cyan toner mother particles D for comparison had a number-based average primary particle size of 6.3 μm, a sphericity of 0.978 and a work function of 5.23 eV.

As apparent from FIG. 11, it is proved that the toner mother particles D contain toner mother particles having an average primary particle size of 3 μm or less in an amount of 5.15% as an integrated value, that is to say, a large amount of fine particles, when the toner mother particles are prepared without ultrasonic application in granulation thereof. On the other hand, as apparent from FIG. 10, it is proved that the toner mother particles 9 of the invention contain toner mother particles having an average primary particle size of 3 μm or less in an amount of 0.23%, substantially close to 0, as an integrated value.

Magenta toner mother particles 5, yellow toner mother particles 5 and black toner mother particles 5 were each prepared in the same manner as described above with the exception that Carmine 6B as a magenta pigment, Pigment Yellow 180 as a yellow pigment and carbon black as a black pigment were each used in place of the cyan pigment described above. Further, magenta toner mother particles D, yellow toner mother particles D and black toner mother particles D were each prepared in the same manner as described above with the exception that the ultrasonic element was not actuated in granulation of magenta toner mother particles 5, yellow toner mother particles 5 and black toner mother particles 5, respectively.

For the respective cyan toner mother particles, the number-based particle size distribution was measured with a flow type particle image analyzer (FPIA-2100) to determine the number-based average primary particle size, the average sphericity and the integrated value of particle sizes of 3 μm or less. The results thereof are shown in Table 11.

TABLE 11

| | | Average | | Integrated |
|---|---|---|---|---|
| | | Primary | | Value of |
| | | Particle | | Particle Sizes of |
| Toner Mother Particle | | Size (μm) | Circularity | 3 μm or Less (%) |
| Example | Magenta Toner | 6.6 | 0.980 | 0.57 |
| | Particles 5 | | | |
| | Yellow Toner | 6.5 | 0.981 | 0.33 |
| | Particles 5 | | | |
| | Black Toner | 6.6 | 0.980 | 0.61 |
| | Particles 5 | | | |
| Comparative | Magenta Toner | 6.4 | 0.978 | 6.10 |
| Example | Particles D | | | |
| | Yellow Toner | 6.3 | 0.977 | 6.23 |
| | Particles D | | | |
| | Black Toner | 6.4 | 0.978 | 7.36 |
| | Particles D | | | |

As apparent from Table 11, for the toner mother particles prepared from emulsions to which the ultrasonic wave had been applied as in the invention, the amount of the toner particles having a particle size of 3 μm or less could be inhibited to a level of substantially 0. However, for the toner mother particles prepared from emulsions to which no ultrasonic wave had been applied, the integrated value of particle sizes of 3 μm or less showed 6 to 7%, and the presence of fine particles was observed. For the work function of the respective toner mother particles, the magenta toner mother particles showed 5.70 eV, the yellow toner mother particles showed 5.51 eV, and the black toner mother particles showed 5.40 eV, regardless of whether the ultrasonic wave had been applied or not.

Then, the respective color toner particles were subjected to external additive treatment in the same manner as with Example 4. However, hydrophobic monodisperse spherical silica particles 2 (work function: 5.20 eV) were used as spherical silica, and calcium stearate was used in the cyan toners and magnesium stearate in the other toners.

Further, using a tandem color printer of a cleanerless system, the image of N-2A “cafeteria” of the standard image data based on JIS X 9201-1995 was continuously printed on 2,000 sheets, and then the toner filming amount on the surface of the latent image carrier for each color was measured by a tape transfer method. The results thereof are shown in Table 12.

The tape transfer method is a method comprising attaching a tape (mending tape, manufactured by Sumitomo 3M Ltd.) to the toner on the latent image carrier (organic photoreceptor), transferring the toner onto the tape, and measuring the weight of the tape to determine the weight of the filmed toner from the difference in tape weight between before and after the tape was attached to the toner.

TABLE 12

| | | Filming Toner Amount |
|---|---|---|
| Toner Mother Particles | | (mg/cm²) |
| Invention | Cyan Toner | 0.003 |
| | Mother Particles 9 | |
| | Magenta Toner | 0.003 |
| | Mother Particles 5 | |
| | Yellow Toner | 0.003 |
| | Mother Particles 5 | |
| | Black Toner | 0.004 |
| | Mother Particles 5 | |
| Comparison | Cyan Toner | 0.020 |
| | Mother Particles D | |
| | Magenta Toner | 0.021 |
| | Mother Particles D | |
| | Yellow Toner | 0.020 |
| | Mother Particles D | |
| | Black Toner | 0.024 |
| | Mother Particles D | |

The results shown in Table 12 indicate that it is possible to make the latent image carrier cleanerless when the integrated value (%) of particle sizes of 3 μm or less is substantially close to 0 such as 1% or less, even in the case of the toner high in sphericity.

As described above, in the non-magnetic single-component negatively chargeable spherical toner of the invention, the hydrophobic monodisperse spherical silica particles functioning as a spacer and having an average particle size of 70 to 130 nm can be prevented from being librated from the toner mother particles, and the external additive particles such as fine inorganic particles having an average particle size of 7 to 50 nm can be prevented from being embedded in the toner mother particles. Accordingly, excellent durability can be attained even in continuous printing, and the transfer residual toner amount and toner filming amount on the latent image carrier can be decreased, so that it is possible to make the latent image carrier cleanerless, and the full color image forming apparatus having no problem in print quality can be provided.

While the present invention has been described in detail and with reference to specific embodiments thereof, it will be apparent to one skilled in the art that various changes and modifications can be made therein without departing from the spirit and scope thereof.

The present application is based on Japanese Patent Application No. 2004-237236 filed on Aug. 17, 2004, and the contents thereof are incorporated herein by reference.

What is claimed is:

1. A non-magnetic monocomponent negatively chargeable spherical toner comprising:
a toner mother particle comprising a binder resin and a colorant; and
an external additive comprising a hydrophobic inorganic fine particle having a number average primary particle size of 7 to 50 nm and a hydrophobic monodisperse spherical silica particle having a number average primary particle size of 70 to 130 nm,
wherein the non-magnetic monocomponent negatively chargeable spherical toner has a mechanical strength of from 7 to 19 MPa, provided that the mechanical strength is determined from a 10% displacement load of a compression-displacement curve obtained in a microcompression test,
wherein the hydrophobic monodisperse spherical silica particle has a work function (Φ_{S}) smaller than a work function (Φ_{TB}) of the toner mother particle.

2. The non-magnetic monocomponent negatively chargeable spherical toner according to claim 1,
wherein, in number-based particle size distribution measured with a flow type particle image analyzer, the toner mother particle have: a number average primary particle size of 9 μm or less; a particle size distribution that has an integrated value of particle sizes of 3 μm or less of 1% or less; and an average sphericity of 0.970 to 0.985.

3. The non-magnetic monocomponent negatively chargeable spherical toner according to claim 1,
wherein the work function (Φ_{TB}) of the toner mother particle is from 5.25 to 5.8 eV, and the work function (Φ_{S}) of the hydrophobic monodisperse spherical silica particle is from 4.90 to 5.20 eV, and the difference between the work function of the toner mother particle and that of the hydrophobic monodisperse spherical silica particle is at least 0.2 eV.

4. The non-magnetic monocomponent negatively chargeable spherical toner according to claim 3,
which further comprises a metal soap particle having: a polarity which is the same as that of the toner mother particle; and a work function of from 5.3 to 5.8 eV,
wherein the work function of the metal soap particle is at least 0.2 eV larger than that of the hydrophobic monodisperse spherical silica particle, and an absolute value of the difference between the work function of the metal soap particle and that of the toner mother particle is 0.15 eV or less.

5. The non-magnetic monocomponent negatively chargeable spherical toner according to claim 1,
wherein the toner mother particle are obtained by a solution suspension method.

6. A full color image forming apparatus comprising:
non-magnetic monocomponent negatively chargeable spherical toners;
a latent image carrier;
a plurality of developing units each for developing an electrostatic latent image, without contacting the latent image carrier, by using the non-magnetic monocomponent negatively chargeable spherical toners so as to form toner images sequentially on the latent image carrier;
an intermediate transfer medium to which the toner images are transferred sequentially so as to form a full color toner image;
a recording material to which the full color toner image is transferred and fixed,
wherein each of the non-magnetic monocomponent negatively chargeable spherical toners comprising:
a toner mother particle comprising a binder resin and a colorant; and
an external additive comprising a hydrophobic inorganic fine particle having a number average primary particle size of 7 to 50 nm and a hydrophobic monodisperse spherical silica particle having a number average primary particle size of 70 to 130 nm,
wherein each of the non-magnetic monocomponent negatively chargeable spherical toners has a mechanical strength of from 7 to 19 MPa, provided that the mechanical strength is determined from a 10% displacement load of a compression-displacement curve obtained in a microcompression test,
wherein the hydrophobic monodisperse spherical silica particle has a work function (Φ_{S}) smaller than a work function (Φ_{TB}) of the toner mother particle, and the intermediate transfer medium has a work function (Φ_{TM}) smaller than that of a work function (Φ_{T}) of each of the non-magnetic monocomponent negatively chargeable spherical toners.

7. The full color image forming apparatus according to claim 6,
wherein, in number-based particle size distribution measured with a flow type particle image analyzer, the toner mother particle have: a number average primary particle size of 9 μm or less; a particle size distribution that has an integrated value of particle sizes of 3 μm or less of 1% or less; and an average sphericity of 0.970 to 0.985.

8. The full color image forming apparatus according to claim 6,
wherein the work function (Φ_{TB}) of the toner mother particle is from 5.25 to 5.8 eV, and the work function (Φ_{S}) of the hydrophobic monodisperse spherical silica particle is from 4.90 to 5.20 eV, and the work function (Φ_{TM}) of the intermediate transfer medium is from 4.9 to 5.5 eV, and the work function (Φ_{T}) of each of the non-magnetic monocomponent negatively chargeable spherical toners is from 5.25 to 5.85 eV,
wherein the difference between the work function of the toner mother particle and that of the hydrophobic monodisperse spherical silica particle is at least 0.2 eV, and the difference between the work function of the intermediate transfer medium and that of each of the non-magnetic monocomponent negatively chargeable spherical toners is at least 0.2 eV.

9. The full color image forming apparatus according to claim 6,
wherein each of the plurality of developing units has a structure in which a toner storage member to which no toner is replenished is integrated with a developing member,
wherein the developing member comprises a developing agent carrier and a toner layer regulating member for regulating a toner layer on the developing agent carrier into approximately one layer.
